(19) United States
(12) Patent Application Publication
(10) Pub. No.: US 2008/0241624 A1
(43) Pub. Date: Oct. 2, 2008

(54) FUEL CELL DEVICE

(75) Inventors: Takahiro Isono, Kobe (JP); Hiroki Kabumoto, Saitama-shi (JP); Takashi Yasuo, Kobe (JP)

Correspondence Address: KNOBBE MARTENS OLSON & BEAR LLP, 2040 MAIN STREET, FOURTEENTH FLOOR, IRVINE, CA, 92614, US

(73) Assignee: Sanyo Electric Co., Ltd., Osaka (JP)

(21) Appl. No.: 12/056,028

(22) Filed: Mar. 26, 2008

(30) Foreign Application Priority Data
Mar. 28, 2007 (JP) 2007-085042
Mar. 28, 2007 (JP) 2007-085104

(51) Int. Cl. H01M 8/10

(52) U.S. Cl. 429/30

(57) ABSTRACT

A fuel cell device is provided that may remove water that has been generated on the surface of a cathode. When the display member of a mobile phone is opened, a shutter member slides from a protection position to an open position. A water absorbing block is thereby moved toward a protrusion portion while contacting the surface of a cathode of a fuel cell, absorbing and removing water that has accumulated on the surface of the cathode. The water absorbing block is moved along the surface of the cathode by simply opening and closing the mobile phone in this manner, and the water that has been generated on the surface of the cathode may be absorbed and removed.

### CROSS-REFERENCE TO RELATED APPLICATION

This application claims priority under 35 USC 119 from Japanese Patent Application No. 2007-085042 and No. 2007-085104, the disclosures of which are incorporated by reference herein.

### BACKGROUND OF THE INVENTION

1. Field of the Invention

The present invention is related to a fuel cell device configured with a mechanism for removing water that has been generated at the surface of a cathode.

2. Description of the Related Art

A natural convection portable fuel cell device is configured with: an anode as a fuel electrode; a cathode as an oxidant electrode; and a solid polymer membrane that is disposed between the anode and the cathode. Hydrogen is supplied as fuel to the anode, and oxygen is supplied as an oxidant to the cathode, and hydrogen, through a solid polymer membrane, and oxygen undergo an electrochemical reaction, and electricity is generated.

At the cathode in such a fuel cell device, hydrogen and oxygen react, and water is generated on the surface of the cathode.

If the generated water accumulates on the surface of the cathode, it becomes difficult for the cathode to take in oxygen, and the electricity generation efficiency of the fuel cell device falls.

To address this issue, as shown in Japanese Patent Application Laid-Open (JP-A) No. 2004-165002, there is a proposal of a fuel cell device provided with a water absorbing sheet, one end of which is disposed at an end portion of the cathode. The water that has been generated on the surface of the cathode may thereby be absorbed from the one end of the water absorbing sheet using capillary action, and the water discharge externally from the other end of the water absorbing sheet.

In such a fuel cell device, however, since it is of a configuration in which the water is absorbed from one end portion of the cathode, it is not possible to sufficiently remove water that has been generated over the entire surface of the cathode (in particular from the central portion thereof), and there is a possibility that the power output of such a fuel cell device will fall.

### SUMMARY OF THE INVENTION

The present invention has been made in view of the above circumstances and provides a fuel cell device.

A first aspect of the present invention provides a fuel cell device including: a fuel cell including an anode as a fuel electrode, a cathode as an oxidant electrode, and a solid polymer membrane that is disposed between the anode and the cathode; a water absorbing member that absorbs water; and a moving unit that moves the water absorbing member along a surface of the cathode.

### BRIEF DESCRIPTION OF THE DRAWINGS

Exemplary embodiments of the present invention will be described in detail based on the following figures, wherein:

FIG. 1A is a side view showing a fuel cell device according to a first exemplary embodiment of the present invention, and the movement of a water absorbing block therein;

FIG. 1B is a side view showing a fuel cell device according to the first exemplary embodiment of the present invention, and the movement of a water absorbing block therein;

FIG. 1C is a side view showing a fuel cell device according to the first exemplary embodiment of the present invention, and the movement of a water absorbing block therein;

FIG. 2 is a cross-sectional view showing a fuel cell of a fuel cell device according to the first exemplary embodiment of the present invention;

FIG. 3A is side view showing a closed state of a mobile phone in which the fuel cell device according to the first exemplary embodiment of the present invention is employed;

FIG. 3B is side view showing an open state of a mobile phone in which the fuel cell device according to the first exemplary embodiment of the present invention is employed;

FIG. 4A is perspective view showing a mobile phone in which the fuel cell device according to the first exemplary embodiment of the present invention is employed;

FIG. 4B is perspective view showing a mobile phone in which the fuel cell device according to the first exemplary embodiment of the present invention is employed;

FIG. 5A is a side view showing a fuel cell device according to a second exemplary embodiment of the present invention, and the movement of a water absorbing sheet therein;

FIG. 5B is a side view showing a fuel cell device according to the second exemplary embodiment of the present invention, and the movement of a water absorbing sheet therein;

FIG. 5C is a side view showing a fuel cell device according to the second exemplary embodiment of the present invention, and the movement of a water absorbing sheet therein;

FIG. 6A is a perspective view showing a fuel cell device according to the second exemplary embodiment of the present invention, and the movement of a water absorbing sheet therein;

FIG. 6B is a perspective view showing a fuel cell device according to the second exemplary embodiment of the present invention, and the movement of a water absorbing sheet therein;

FIG. 6C is a perspective view showing a fuel cell device according to the second exemplary embodiment of the present invention, and the movement of a water absorbing sheet therein;

FIG. 7A is a side view showing a fuel cell device according to a third exemplary embodiment of the present invention, and the movement of a water absorbing sheet therein;

FIG. 7B is a side view showing a fuel cell device according to the third exemplary embodiment of the present invention, and the movement of a water absorbing sheet therein;

FIG. 7C is a side view showing a fuel cell device according to the third exemplary embodiment of the present invention, and the movement of a water absorbing sheet therein;

FIG. 8A is a perspective view showing a fuel cell device according to the third exemplary embodiment of the present invention, and the movement of a water absorbing sheet therein;

FIG. 8B is a perspective view showing a fuel cell device according to the third exemplary embodiment of the present invention, and the movement of a water absorbing sheet therein;

FIG. 8C is a perspective view showing a fuel cell device according to the third exemplary embodiment of the present invention, and the movement of a water absorbing sheet therein;

FIG. 9A is a side view showing a fuel cell device according to a fourth exemplary embodiment of the present invention, and the movement of a water absorbing block therein;

FIG. 9B is a side view showing a fuel cell device according to the fourth exemplary embodiment of the present invention, and the movement of a water absorbing block therein;

FIG. 9C is a side view showing a fuel cell device according to the fourth exemplary embodiment of the present invention, and the movement of a water absorbing block therein;

FIG. 10A is a perspective view showing a fuel cell device according to the fourth exemplary embodiment of the present invention, and the movement of a water absorbing block therein;

FIG. 10B is a perspective view showing a fuel cell device according to the fourth exemplary embodiment of the present invention, and the movement of a water absorbing block therein;

FIG. 10C is a perspective view showing a fuel cell device according to the fourth exemplary embodiment of the present invention, and the movement of a water absorbing block therein;

FIG. 11 is a flow diagram showing an operation mode of a water absorbing block of a fuel cell device according to the fourth exemplary embodiment of the present invention;

FIG. 12A is a plan view showing a water absorbing block and a fuel cell of a fuel cell device according to the fourth exemplary embodiment of the present invention;

FIG. 12B is a plan view showing a water absorbing block and a fuel cell of a fuel cell device according to the fourth exemplary embodiment of the present invention;

FIG. 13A is a side view showing a fuel cell device according to a fifth exemplary embodiment of the present invention, and the movement of a water absorbing roll therein;

FIG. 13B is a side view showing a fuel cell device according to the fifth exemplary embodiment of the present invention, and the movement of a water absorbing roll therein;

FIG. 13C is a side view showing a fuel cell device according to the fifth exemplary embodiment of the present invention, and the movement of a water absorbing roll therein;

FIG. 14A is a perspective view showing a fuel cell device according to the fifth exemplary embodiment of the present invention, and the movement of a water absorbing roll therein;

FIG. 14B is a perspective view showing a fuel cell device according to the fifth exemplary embodiment of the present invention, and the movement of a water absorbing roll therein;

FIG. 14C is a perspective view showing a fuel cell device according to the fifth exemplary embodiment of the present invention, and the movement of a water absorbing roll therein;

FIG. 15A is a perspective view showing a fuel cell device according to a sixth exemplary embodiment of the present invention, and the movement of a water absorbing sheet therein;

FIG. 15B is a perspective view showing a fuel cell device according to the sixth exemplary embodiment of the present invention, and the movement of a water absorbing sheet therein;

FIG. 15C is a perspective view showing a fuel cell device according to the sixth exemplary embodiment of the present invention, and the movement of a water absorbing sheet therein;

FIG. 16A is a side view showing a fuel cell device according to a seventh exemplary embodiment of the present invention, and the movement of a water absorbing sheet strip therein;

FIG. 16B is a side view showing a fuel cell device according to the seventh exemplary embodiment of the present invention, and the movement of a water absorbing sheet strip therein;

FIG. 16C is a side view showing a fuel cell device according to the seventh exemplary embodiment of the present invention, and the movement of a water absorbing sheet strip therein;

FIG. 17A is a perspective view showing a fuel cell device according to the seventh exemplary embodiment of the present invention, and the movement of a water absorbing sheet strip therein;

FIG. 17B is a perspective view showing a fuel cell device according to the seventh exemplary embodiment of the present invention, and the movement of a water absorbing sheet strip therein;

FIG. 17C is a perspective view showing a fuel cell device according to the seventh exemplary embodiment of the present invention, and the movement of a water absorbing sheet strip therein;

FIG. 18A is a side view showing a fuel cell device according to an eighth exemplary embodiment of the present invention, and the movement of a water absorbing sheet therein;

FIG. 18B is a side view showing a fuel cell device according to the eighth exemplary embodiment of the present invention, and the movement of a water absorbing sheet therein;

FIG. 18C is a side view showing a fuel cell device according to the eighth exemplary embodiment of the present invention, and the movement of a water absorbing sheet therein;

FIG. 19A is a perspective view showing a fuel cell device according to a ninth exemplary embodiment of the present invention, and the movement of a water absorbing block therein;

FIG. 19B is a perspective view showing a fuel cell device according to the ninth exemplary embodiment of the present invention, and the movement of a water absorbing block therein;

FIG. 19C is a perspective view showing a fuel cell device according to the ninth exemplary embodiment of the present invention, and the movement of a water absorbing block therein;

FIG. 20A is a side view showing a fuel cell device according to a tenth exemplary embodiment of the present invention, and the movement of a water absorbing sheet therein;

FIG. 20B is a side view showing a fuel cell device according to the tenth exemplary embodiment of the present invention, and the movement of a water absorbing sheet therein;

FIG. 21A is a side view showing a fuel cell device according to the tenth exemplary embodiment of the present invention, and the movement of a water absorbing sheet therein;

FIG. 21B is a side view showing a fuel cell device according to the tenth exemplary embodiment of the present invention, and the movement of a water absorbing sheet therein;

FIG. 22 is a cross-sectional view showing a wheel of a fuel cell device according to the tenth exemplary embodiment of the present invention;

FIG. 23 is a plan view showing a fuel cell device according to the tenth exemplary embodiment of the present invention;

FIG. 24A is a plan view showing a water absorbing block and a fuel cell of a fuel cell device according to an eleventh exemplary embodiment of the present invention;

FIG. 24B is a plan view showing a water absorbing block and a fuel cell of a fuel cell device according to the eleventh exemplary embodiment of the present invention;

FIG. 25A is a plan view showing a water absorbing block and a fuel cell of a fuel cell device according to a twelfth exemplary embodiment of the present invention;

FIG. 25B is a plan view showing a water absorbing block and a fuel cell of a fuel cell device according to the twelfth exemplary embodiment of the present invention;

FIG. 26A is a plan view showing a water absorbing block and a fuel cell of a fuel cell device according to a thirteenth exemplary embodiment of the present invention;

FIG. 26B is a plan view showing a water absorbing block and a fuel cell of a fuel cell device according to the thirteenth exemplary embodiment of the present invention;

FIG. 27A is a plan view showing a water absorbing block and a fuel cell of a fuel cell device according to a fourteenth exemplary embodiment of the present invention;

FIG. 27B is a plan view showing a water absorbing block and a fuel cell of a fuel cell device according to the fourteenth exemplary embodiment of the present invention;

FIG. 28A is a perspective view showing a fuel cell device according to a fifteenth exemplary embodiment of the present invention, and the movement of a water absorbing block therein;

FIG. 28B is a perspective view showing a fuel cell device according to the fifteenth exemplary embodiment of the present invention, and the movement of a water absorbing block therein;

FIG. 28C is a perspective view showing a fuel cell device according to the fifteenth exemplary embodiment of the present invention, and the movement of a water absorbing block therein;

FIG. 29A is a side view showing a fuel cell device according to the fifteenth exemplary embodiment of the present invention, and the movement of a water absorbing block therein;

FIG. 29B is a side view showing a fuel cell device according to the fifteenth exemplary embodiment of the present invention, and the movement of a water absorbing block therein;

FIG. 29C is a side view showing a fuel cell device according to the fifteenth exemplary embodiment of the present invention, and the movement of a water absorbing block therein;

FIG. 30 is a perspective view showing a mobile phone in which a fuel cell device according to the fifteenth exemplary embodiment of the present invention is employed;

FIG. 31A is a perspective view showing a fuel cell device according to a sixteenth exemplary embodiment of the present invention, and the movement of a water absorbing block therein;

FIG. 31B is a perspective view showing a fuel cell device according to the sixteenth exemplary embodiment of the present invention, and the movement of a water absorbing block therein;

FIG. 31C is a perspective view showing a fuel cell device according to the sixteenth exemplary embodiment of the present invention, and the movement of a water absorbing block therein;

FIG. 32A is a perspective view showing a fuel cell according to the sixteenth exemplary embodiment of the present invention;

FIG. 32B is a cross-sectional view showing a fuel cell according to the sixteenth exemplary embodiment of the present invention;

FIG. 33A is a perspective view showing a fuel cell device according to a seventeenth exemplary embodiment of the present invention, and the movement of a water absorbing block therein;

FIG. 33B is a perspective view showing a fuel cell device according to the seventeenth exemplary embodiment of the present invention, and the movement of a water absorbing block therein;

FIG. 33C is a perspective view showing a fuel cell device according to the seventeenth exemplary embodiment of the present invention, and the movement of a water absorbing block therein;

FIG. 34A is a perspective view showing a fuel cell device according to an eighteenth exemplary embodiment of the present invention, and the movement of a water absorbing block therein;

FIG. 34B is a perspective view showing a fuel cell device according to the eighteenth exemplary embodiment of the present invention, and the movement of a water absorbing block therein;

FIG. 34C is a perspective view showing a fuel cell device according to the eighteenth exemplary embodiment of the present invention, and the movement of a water absorbing block therein;

FIG. 35A is a perspective view showing a fuel cell according to the eighteenth exemplary embodiment of the present invention;

FIG. 35B is a cross-sectional view showing a fuel cell according to the eighteenth exemplary embodiment of the present invention;

FIG. 36A is a side view showing a fuel cell device according to a nineteenth exemplary embodiment of the present invention, and the movement of a water absorbing block therein;

FIG. 36B is a side view showing a fuel cell device according to the nineteenth exemplary embodiment of the present invention, and the movement of a water absorbing block therein;

FIG. 36C is a side view showing a fuel cell device according to the nineteenth exemplary embodiment of the present invention, and the movement of a water absorbing block therein;

FIG. 37A is a perspective view showing a fuel cell device according to the nineteenth exemplary embodiment of the present invention, and the movement of a water absorbing block therein;

FIG. 37B is a perspective view showing a fuel cell device according to the nineteenth exemplary embodiment of the present invention, and the movement of a water absorbing block therein; and

FIG. 37C is a perspective view showing a fuel cell device according to the nineteenth exemplary embodiment of the present invention, and the movement of a water absorbing block therein.

### DETAILED DESCRIPTION OF THE INVENTION

Herebelow, an example of an exemplary embodiment of the present invention will be described in detail with reference to the drawings.

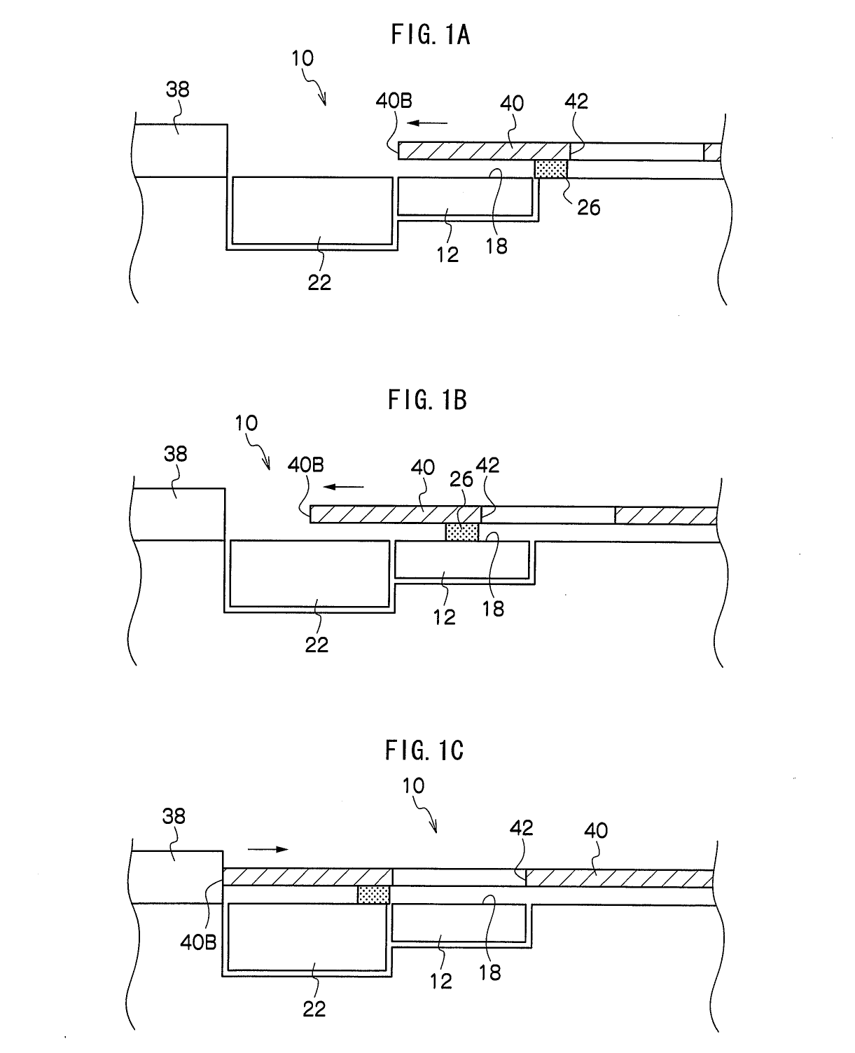

Explanation will now be given of a mobile phone employing a fuel cell device according to a first exemplary embodiment of the present invention, with reference to FIGS. 1A to 4B.

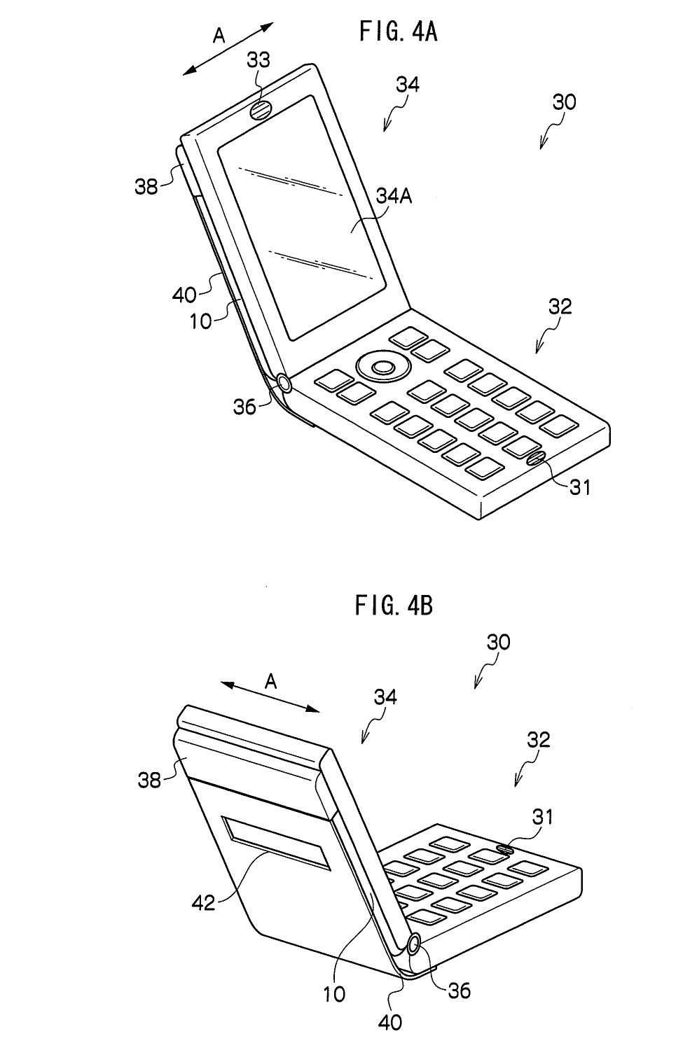

A mobile phone 30, as shown in FIGS. 4A and 4B, is provided with: a plate-shaped operation member 32 (body) with various operation keys, such as a power switch, and with a microphone 31; a display member 34 (opening and closing portion) with a display screen 34A for displaying information and the like based on information from the operation member 32, and with a speaker 33; and a hinge member 36, which is able to maintain the display member 34 in an open or closed state with respect to the operation member 32.

A fuel cell device 10, for supplying power to the mobile phone 30, is attached to the back face of the display member 34 (the face that is not provided with the display screen 34A). In order to protect the fuel cell device 10 there is, in addition, a thin plate-shaped shutter member 40 provided so as to cover the fuel cell device 10 from the outside. There is also a protrusion portion 38 provided to an end portion of the display member 34, to which the shutter member 40 abuts. There is also a rectangular opening portion 42 provided in the shutter member 40, through which air (oxygen) is supplied as an oxidant to the fuel cell device 10. Detailed explanation of the shutter member 40 is given later.

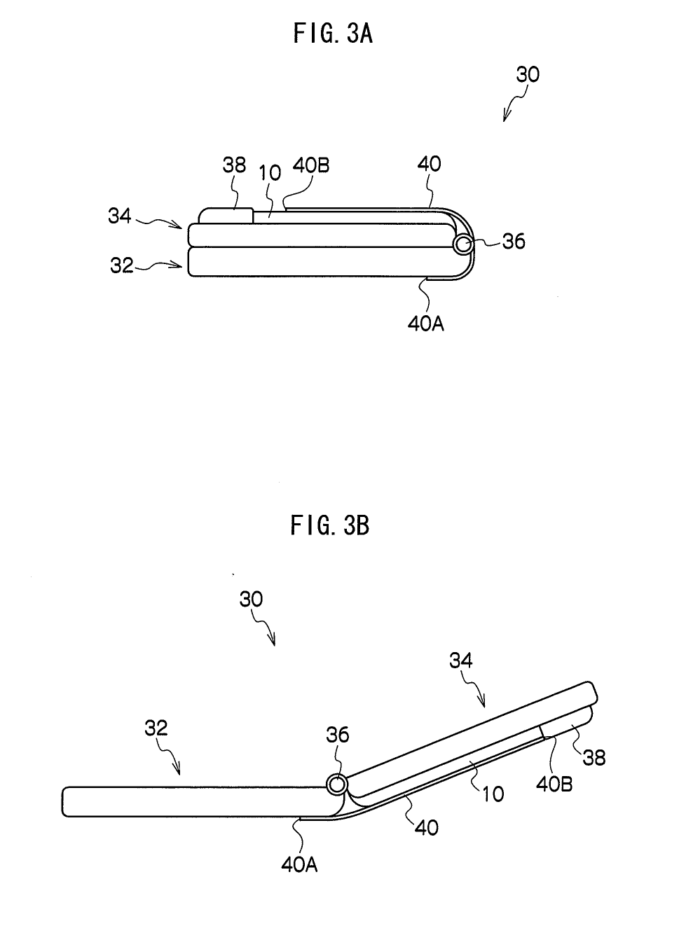

When the mobile phone 30 is not being used, as shown in FIG. 3A, the mobile phone 30 may be placed in a non-operational state by a user rotating the display member 34 about the hinge member 36 as the center of rotation and superimposing the display member 34 on the operation member 32. On the other hand, when using the mobile phone 30, the mobile phone 30 may be placed in a state in which operation can be carried out by a user rotating the display member 34 about the hinge member 36 as the center of rotation and opening-out the display member 34. It should be noted that a non-illustrated hinge stopper is provided to the hinge member 36, and the display member 34 is maintained at the open angle shown in FIG. 3B.

The shutter member 40 is a flexible metal plate and one end portion 40A of the shutter member 40 is fixed to the rear face of the operation member 32. There are also rail members (omitted from the figures) provided at portions at both sides of the shutter member 40 which enable the shutter member 40 to slide along the plate face of the fuel cell device 10.

The shutter member 40, by such a configuration, bends or becomes in a substantially linear state with the closing and opening movements of the mobile phone 30, and the other end portion 40B of the shutter member 40 slides along the surface of the fuel cell device 10.

When the mobile phone 30 is in the non-operation state, as shown in FIGS. 1A and 3A, the other end portion 40B of the shutter member 40 is separated from the protrusion portion 38, and the shutter member 40 covers a fuel cell 12, described later, of the fuel cell device 10, and slides to a protection position that protects the fuel cell 12.

On the other hand, when the mobile phone 30 is in the operation state, as shown in FIGS. 1C and 3B, the other end portion 40B of the shutter member 40 slides until it abuts the protrusion portion 38, and the opening portion 42 faces the fuel cell 12 so that oxygen is able to be supplied thereto.

There is also a fuel cartridge 22 provided adjacent to the fuel cell 12, and the fuel cartridge 22 supplies fuel through a non-illustrated supply pipe to the fuel cell 12.

Explanation will now be given of the configuration of the fuel cell 12.

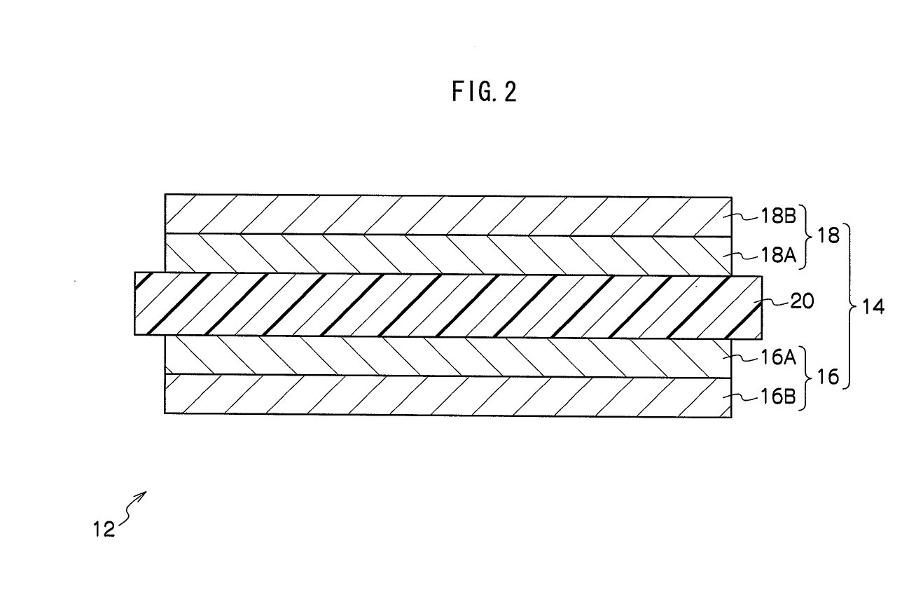

The fuel cell 12, as shown in FIG. 2, has single or plural membrane electrode assemblies (MEAs) 14.

The membrane electrode assembly 14 is provided with an anode 16 as a fuel electrode, a cathode 18 as an oxidant electrode, and a solid polymer membrane 20 disposed between the anode 16 and the cathode 18.

The solid polymer membrane 20 has the functions of separating the anode 16 from the cathode 18, and of letting hydrogen ions move between the two electrodes. The solid polymer membrane 20 is therefore preferably a membrane with a high hydrogen ion conductivity. It is also preferable that the solid polymer membrane 20 is chemically stable and has high mechanical strength. Organic polymers with polar groups, such as strong acidic groups like sulfone groups or phosphate groups, or weak acidic groups, such as carboxyl groups, may be preferably used as materials for the solid polymer membrane 20. Examples of such organic polymers include aromatic condensation polymers such as sulphonated poly (4-phenoxybenzoyl-1,4-phenylene) and alkyl sulfonated polybenzimidazole, perfluorocarbons containing sulfone groups (NAFION (registered trade mark, produced by DuPont), ACIPLEX (produced by Asahi Kasei Corporation)) and perfluorocarbons containing carboxyl groups (FLEMION S (registered trade mark, produced by Asahi Glass Co., Ltd.)), and the like.

In addition, the anode 16 and the cathode 18 may be configured from an anode side catalytic layer 16A and a cathode side catalytic layer 18A respectively, layers that include catalyst holding carbon particles and solid electrolyte particles and that are formed respectively on an anode substrate 16B and a cathode substrate 18B.

Examples of the anode side catalytic layer 16A catalyst include platinum, gold, silver, ruthenium, rhodium, palladium, osmium, iridium, cobalt, nickel, rhenium, lithium, lanthanum, strontium, yttrium, and alloys thereof.

Similar catalysts as used on the anode side catalytic layer 16A may be used as the cathode side catalytic layer 18A catalysts, and the above materials may be used. It should be noted that either the same or different materials may be used for the catalyst of the anode side catalytic layer 16A and the catalyst of the cathode side catalytic layer 18A.

Examples of the catalyst holding carbon particles include acetylene black (such as DENKA BLACK (registered trade mark, produced by Denki Kagaku Kogyo Kabushiki Kaisha) and VULCAN XC72 (produced by Cabot Corporation)), ketjen black, carbon nanotubes, and carbon nanohoms.

The solid electrolyte particles of the anode side catalytic layer 16A and the cathode side catalytic layer 18A may be the same as each other or different from each other. The same materials as those of the solid polymer membrane 20 may be used for the solid electrolyte particles, however, different materials may be used to those of the solid polymer membrane 20 and plural materials may also be used.

Furthermore, porous bodies may be used for the anode substrate 16B and the cathode substrate 18B, such as carbon paper, carbon molded bodies, carbon sintered bodies, sintered metals and metal foams.

When methanol or ethanol are used as fuel, carbon dioxide bubbles are generated as a byproduct when hydrogen ions are formed from methanol or ethanol on the anode 16. Accumulation of such carbon dioxide bubbles on the anode substrate 16B is a cause of a reduction in the efficiency of electricity generation. The cause of bubbles accumulating is that water covering the bubbles adheres to the anode substrate 16B, and accumulates there.

It is preferable, in this respect, that the surface of the anode substrate 16B is surface treated with a hydrophilic or hydrophobic coating agent. By surface treating with a hydrophilic coating agent, the flowability of the fuel over the surface of the anode substrate 16B is raised. The carbon dioxide bubbles are thereby readily moved with the fuel.

By surface treating with a hydrophobic coating agent, the adherence of water to the anode substrate 16B, which is the cause of bubble formation, may be reduced. The formation of bubbles on the surface of the anode substrate 16B may thereby be reduced. Examples of hydrophilic coating agents include titanium oxide, silicon oxide and the like. Examples of hydrophobic coating agents include polytetrafluoroethylene, polyethylene, silanes and the like. The surface of the cathode substrate 18B may also be surface treated in a similar manner. In particular, by surface treating the surface of the cathode substrate 18B with the hydrophobic coating agent, water does not readily accumulate on the surface of the cathode 18, and water may be efficiently removed from the surface of the cathode 18.

In the fuel cell 12 configured in such a manner, fuel from the fuel cartridge 22 (see FIGS. 1A and 1C) is supplied to the anode 16, and air (oxygen) as an oxidant is supplied to the cathode 18, and electricity is generated in the fuel cell 12 by an electrochemical reaction.

Substances that may be used as fuel include liquid fuels such as methanol, ethanol, dimethylether and other alcohols, liquid hydrocarbons such as cycloparaffin, and formalin, formic acid and hydrazine. Aqueous solutions may be used for liquid fuels. Alkalies may also be added to fuels. The hydrogen ion conductivity may thereby be raised.

Usually air is used for the oxidant, but oxygen gas may also be supplied.

When hydrogen is used as the fuel, the reaction at the anode 16 is as set out in equation (1).

3H₂ [symbol] 6H⁺+6e⁻ (1)

When methanol is used as the fuel, the reaction at the anode 16 is as set out in equation (2).

CH₃OH+H₂O [symbol] 6H⁺+CO₂+6e⁻ (2)

In both of these cases the hydrogen ions migrate through the solid polymer membrane 20 and undertake a reaction at the cathode 18, as set out in equation (3) below.

3/2O₂+6H⁺+6e⁻ [symbol] 3H₂O

In the fuel cell 12 such as this, as shown in the above equation (3), water is generated at the cathode 18. Water also passes through the solid polymer membrane 20 with the hydrogen ions that have been generated at the anode 16, passing through the solid polymer membrane 20 to reach the cathode 18, and water accumulates at the surface of the cathode 18.

If water accumulates at the surface of the cathode, it becomes difficult for oxygen to be taken in, the electricity generating efficiency of the fuel cell device 10 decreases, and the output thereof also decreases.

Explanation will now be given of the water absorbing member that removes water accumulating on the surface of the cathode 18.

As shown in FIG. 1A, there is a rectangular cross-section water absorbing block 26 fixed with adhesive or the like to the rear face of the shutter member 40, along the edge portion of the opening portion 42, and disposed at the side of the fuel cell 12 when the shutter member 40 is in the protection position. It should be noted that a hydrophilic porous material is used for the water absorbing block 26. Porous bodies may be used that are made from, for example, felt, sponge, resin particle sintered bodies, resin fiber sintered bodies, natural fibers, resin fiber bundles and the like. Further, it is preferable that a substance such as polyester or rayon is used for the water absorbing block 26.

The thickness of the water absorbing block 26 is about the same as the distance between the rear face of the shutter member 40 and the front face of the cathode 18, or greater than this distance. The dimension of the water absorbing block 26 in the width direction (the direction into the page in FIGS. 1A to 1C) is longer than the length of the width direction of the cathode 18 of the fuel cell 12.

Explanation will now be given of the movement of the water absorbing block 26 for removing water that accumulates on the surface of the cathode 18.

In the non-operation state of the mobile phone 30, as shown in FIG. 1A, the shutter member 40 is positioned in the protection position, and the water absorbing block 26 is disposed at the side of the fuel cell 12.

When the display member 34 of the mobile phone 30 is opened out, the shutter member 40 slides, as shown in FIG. 1B, from the protection position toward an open position. The water absorbing block 26 is thereby moved toward the protrusion portion 38 while also contacting the surface of the cathode 18 of the fuel cell 12, and absorbs and removes water that has accumulated on the surface of the cathode 18.

In the operation state of the mobile phone 30, as shown in FIG. 1C, the shutter member 40 moves to the open position, the water absorbing block 26 passes past the fuel cell 12 and is disposed above the fuel cartridge 22.

In this manner, by simply opening and closing the mobile phone 30, the water absorbing block 26 is moved along the surface of the cathode 18, and water that has been generated on the surface of the cathode 18 may be absorbed and removed.

Since the width dimension of the water absorbing block 26 is longer than the width dimension of the cathode 18, the water absorbing block 26 passes past the entire surface of the cathode 18, and is able to remove all of the water that has been generated on the surface of the cathode 18. It should be noted that a configuration may also be made in which the water absorbing block 26 does not contact with the surface of the cathode 18, but contacts with the liquid surface of water droplets that have adhered to the surface of the cathode 18 so as to absorb water.

Since operation of the water absorbing block 26 may be made without consuming any electricity, running costs may also be reduced.

It should be noted that while detailed explanation has been made of a particular exemplary embodiment of the present invention, the present invention is not limited to this exemplary embodiment, and it will be clear to a person of skill in the art that various other embodiments are possible within the scope of the present invention. For example, in the above exemplary embodiment the fuel cell device 10 is used in a mobile phone 30 that is provided with an opening and closing display member 34, however, such a fuel cell device may be used, instead, in a portable computer, or a portable game console, which is provided with an opening and closing display member.

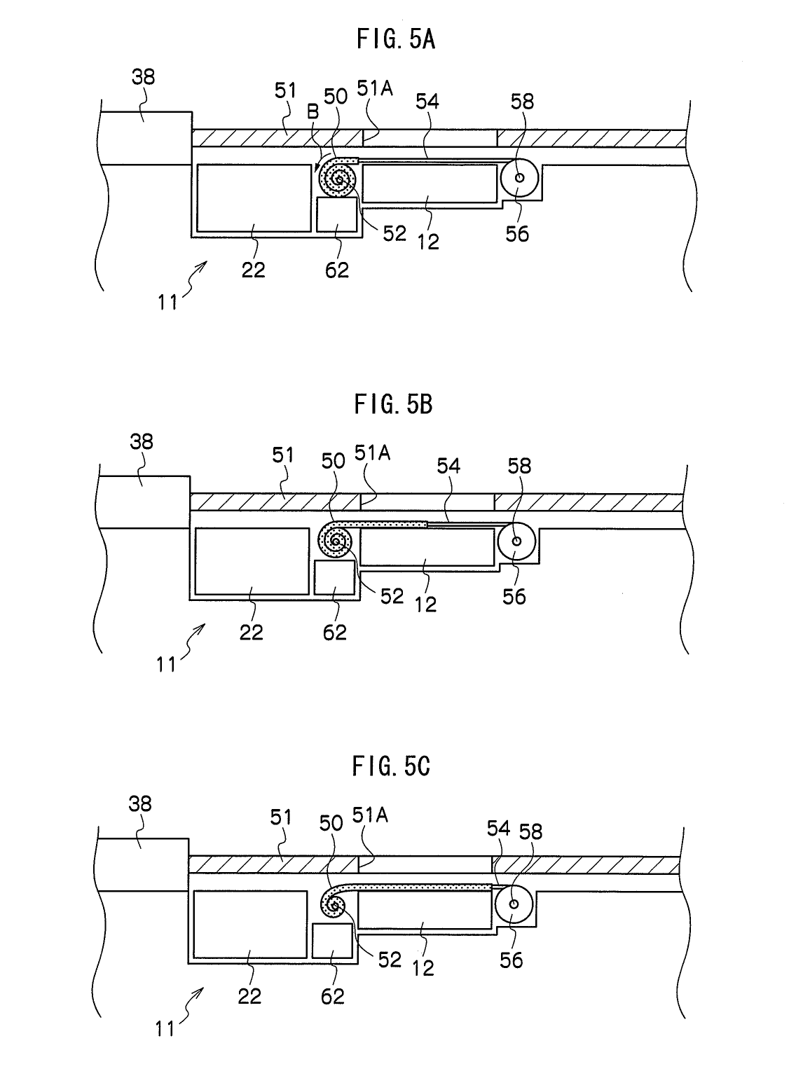

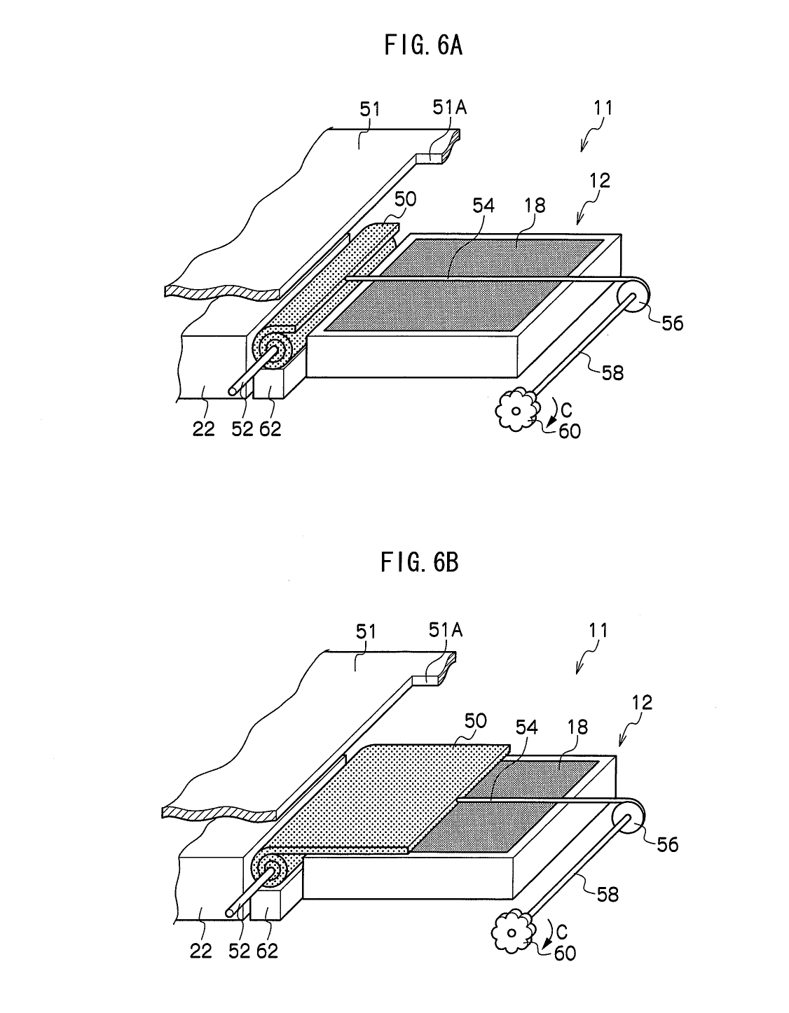

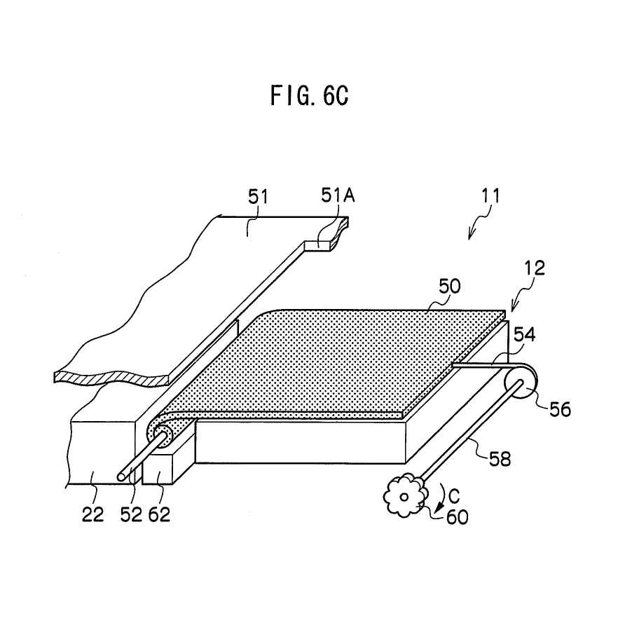

Explanation will now be given of a mobile phone 30 employing a fuel cell device 11 according to a second exemplary embodiment of the present invention, with reference to FIGS. 5A to 6C.

It should be noted that similar components to those of the first exemplary embodiment are allocated the same reference numerals, and explanation thereof is omitted.

In this exemplary embodiment, as shown in FIG. 5A, a sheet-shaped water absorbing sheet 50 that is stored on a take-up shaft 52 is provided between the fuel cartridge 22 and the fuel cell 12, instead of the water absorbing block 26 of the first exemplary embodiment. There is also a non-illustrated coil spring provided to the take-up shaft 52 that winds up the water absorbing sheet 50, the coil spring imparting a biasing force to the take-up shaft 52 in the take-up direction of the water absorbing sheet 50 (shown as the direction of arrow B in FIG. 5A). The water absorbing sheet 50 is thereby, in a state in which there is no external force applied, wound up on the take-up shaft 52.

A leading edge portion of the water absorbing sheet 50 that has been wound up on the take-up shaft 52 is, as shown in FIG. 6A, attached to one end of a wire 54, and the other end of the wire 54 is fixed to a pulley 56 that has been provided in a position facing the water absorbing sheet 50 with the fuel cell 12 positioned therebetween. The pulley 56 is rotatably supported by a non-illustrated bracket, and at one end of a rotational shaft 58 of the pulley 56 there is provided a substantially circular shaped dial 60 that protrudes to the outside of the mobile phone 30 and that is able to be rotated by hand. There are also guide members (omitted in the figures) provided at the two sides of the fuel cell 12, which guide the two edge portions of the water absorbing sheet 50 that has been pulled out by the wire 54.

A water absorbing box 62 is provided below the take-up shaft 52 as a collection unit for collecting water that has been absorbed by the water absorbing sheet 50, and a porous member (omitted in the figures) is provided within the water absorbing box 62, for absorbing water that has comes out from the surface of the water absorbing sheet 50 when the water absorbing sheet 50 is wound up on the take-up shaft 52 by biasing force of the coil spring.

The fuel cell 12, fuel cartridge 22 and water absorbing sheet 50 are covered by a cover 51, and there is an opening portion 51A formed in the cover 51 in a position thereof that faces the fuel cell 12 so that air can be taken in.

Explanation will now be given of the movement of the water absorbing sheet 50 for removing water that has accumulated on the surface of the cathode 18.

In the state in which there is no rotational force applied to the dial 60, as shown in FIGS. 5A and 6A, the water absorbing sheet 50 is in the state in which it is wound up on the take-up shaft 52.

When the dial 60 is rotated in the direction of arrow C with the rotational shaft 58 as the center of rotation, as shown in FIGS. 5B and 6B, the pulley 56 also rotates therewith, and the pulley 56 winds up the wire 54.

By the pulley 56 winding up the wire 54, the water absorbing sheet 50 that is attached to one end of the wire 54 moves and is opened out into a planar state along the surface of the cathode 18 while being guided by the guide members.

When the water absorbing sheet 50 is opened out into a planar state, as shown in FIGS. 5C and 6C, covering all of the surface of the cathode 18, further rotational movement of the dial 60 in the direction of arrow C is then prevented from by a non-illustrated stopper.

When load is then release from the dial 60, the water absorbing sheet 50 is wound up on the take-up shaft 52, as shown in FIG. 6A, by biasing force of the coil spring that is provided to the take-up shaft 52.

Furthermore, when the water absorbing sheet 50 is wound up on the take-up shaft 52 by biasing force of the coil spring, the water that has been absorbed in the water absorbing sheet 50 comes out from the surface of the water absorbing sheet 50. The water that comes out is absorbed in the porous material (omitted in the figures) that is provided in the water absorbing box 62.

In this manner, by simply rotating the dial 60, the water absorbing sheet 50 may be unwound into a planer state along the surface of the cathode 18, and the water that has been generated at the surface of the cathode 18 may be removed.

Furthermore, since the water absorbing box 62 collects the water that has been absorbed in the water absorbing sheet 50, the water absorbing sheet 50 is able to sufficiently remove water that has been generated at the surface of the cathode 18 even when the water absorbing sheet 50 is used the next time.

It should be noted that while detailed explanation has been made of a particular exemplary embodiment of the present invention, the present invention is not limited to this exemplary embodiment, and it will be clear to a person of skill in the art that various embodiments are possible within the scope of the present invention. For example, a single wire is used in the above exemplary embodiment for pulling out the water absorbing sheet 50, but instead plural wires may be used for pulling out the water absorbing sheet 50. The water absorbing sheet 50 may be pulled out in a stable state in such a case.

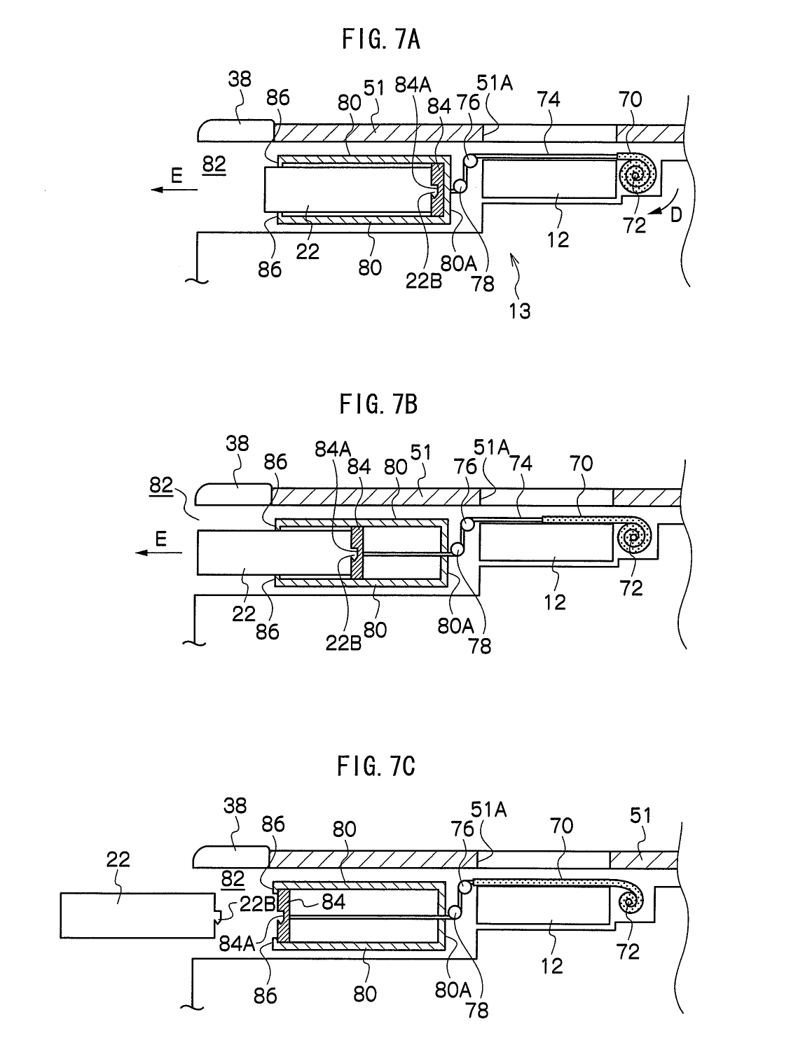

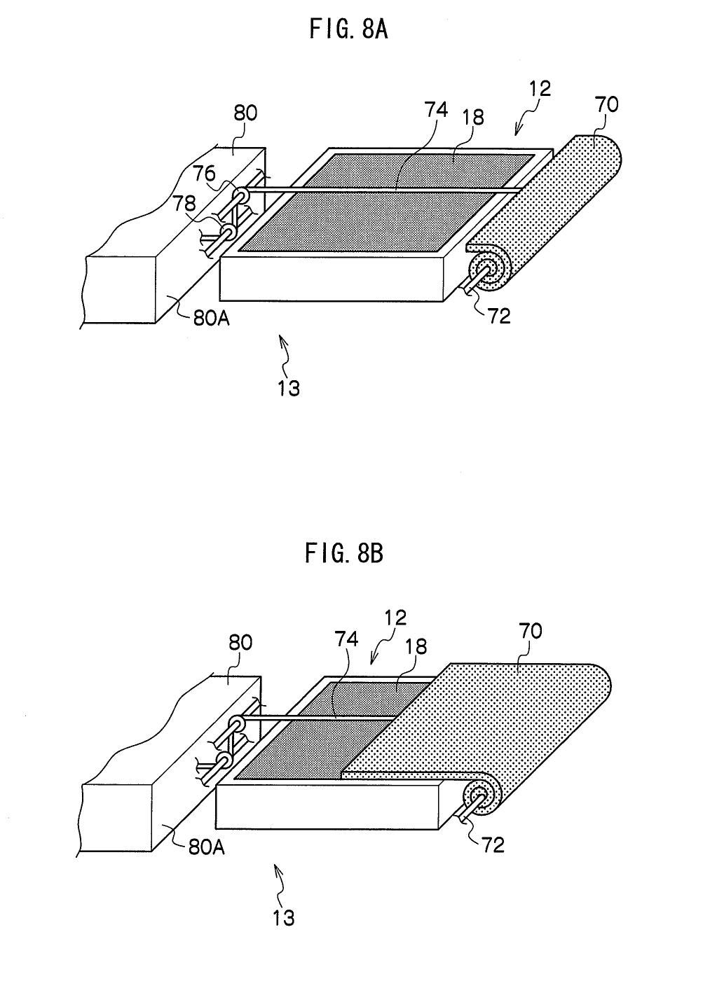

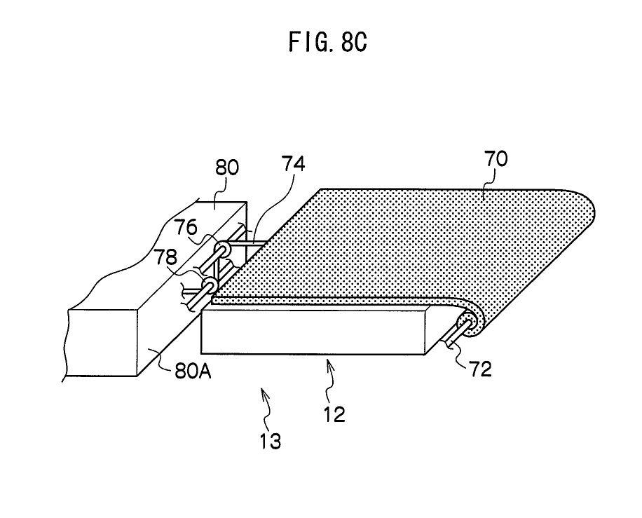

Explanation will now be given of a mobile phone 30 employing a fuel cell device 13 according to a third exemplary embodiment of the present invention, with reference to FIGS. 7A to 8C.

It should be noted that similar components to those of the first exemplary embodiment are allocated the same reference numerals, and explanation thereof is omitted.

In this exemplary embodiment, as shown in FIG. 7A, instead of the water absorbing block 26 of the first exemplary embodiment, a sheet-shaped water absorbing sheet 70 is stored by being wound up on a take-up shaft 72 that is positioned facing the fuel cartridge 22 with the fuel cell 12 positioned therebetween.

The take-up shaft 72 for winding up the water absorbing sheet 70 is provided with a non-illustrated coil spring for biasing the take-up shaft 72 in the water absorbing sheet 70 take up direction (shown as direction D in FIG. 7A). The water absorbing sheet 70 is thereby wound up on the take-up shaft 72 in a state in which there is no external load applied.

A leading edge portion of the water absorbing sheet 70 that has been stored is, as shown in FIG. 8A, attached to one end of a wire 74, and the other end of the wire 74 extends along the surface of the cathode 18, and is wound around a fixed pulley 76 that is disposed between the fuel cell 12 and the fuel cartridge 22 and extends in a downward direction. The other end of the wire 74 that is extended in the downward direction is wound around a fixed pulley 78 that is disposed below the fixed pulley 76, and passes through a back wall 80A of a fuel cartridge case 80 that accommodates the fuel cartridge 22, and is inserted into the inside of the fuel cartridge case 80. Guide members (omitted in the figures) are provided at the two sides of the fuel cell 12 and these guide members guide the two edge portions of the water absorbing sheet 70 that has been pulled out by the wire 74.

There is a replacement space 82 provided at the protrusion portion 38 where the fuel cartridge 22 is able to be replaced. The fuel cartridge 22 is thereby replaceable from the side opposite to the back wall 80A.

There is also a push-pull plate 84 provided to the inside of the fuel cartridge case 80 from the back wall 80A, and the other end of the above wire 74 is fixed thereto. There is an indented engaging recess portion 84A provided to the fuel cartridge 22 side of the push-pull plate 84, such that an engaging protrusion portion 22B that is provided to the fuel cartridge 22 is engaged therewith. Thereby, it is configured such that when the fuel cartridge 22 is pulled out in the direction shown by arrow E in FIG. 7A, since the engaging protrusion portion 22B and the engaging recess portion 84A are engaged, the push-pull plate 84 slides in the direction of arrow E together with the fuel cartridge 22.

There is a pull-catch portion 86 provided protruding out to the inside from an edge portion of the fuel cartridge case 80 that is opened up for replacing the fuel cartridge 22. When the fuel cartridge 22 is replaced, as shown in FIG. 7C, the push-pull plate 84 that has been slid out with the fuel cartridge 22 abuts the pull-catch portion 86, and the engagement of the engaging protrusion portion 22B with the engaging recess portion 84A is released, such that the push-pull plate 84 remains behind within the fuel cartridge case 80.

The fuel cell 12, fuel cartridge 22 and water absorbing sheet 70 are covered by the cover 51, and there is an opening portion 51A formed in the cover 51 in a position thereof that faces the fuel cell 12 such that air may be taken in.

Explanation will now be given of the movement of the water absorbing sheet 70 for removing water that has accumulated on the surface of the cathode 18.

In the state in which the fuel cartridge 22 is accommodated in the fuel cartridge case 80, as shown in FIGS. 7A and 8A, the water absorbing sheet 70 is in a state of being wound up on the take-up shaft 72 by biasing force of the coil spring. When the fuel cartridge 22 is then replaced, a user pulls the fuel cartridge 22 out in the direction of the arrow E.

When the fuel cartridge 22 is pulled out in the direction of arrow E, as shown in FIGS. 7B and 8B, since the engaging protrusion portion 22B of the fuel cartridge 22 is engaged with the engaging recess portion 84A of the push-pull plate 84, the push-pull plate 84 slides out in the direction of arrow E together with the fuel cartridge 22.

The other end of the wire 74 is pulled by the sliding of the push-pull plate 84, and the water absorbing sheet 70 that is attached to the one end of the wire 74 is moved and opened out into a planar state along the surface of the cathode 18, while being guided by the non-illustrated guide portions.

When the water absorbing sheet 70 is opened out into the planar state covering the entire surface of the cathode 18, as shown in FIGS. 7C and 8C, the push-pull plate 84 abuts the pull-catch portion 86, and engagement of the engaging protrusion portion 22B with the engaging recess portion 84A is released, such that the push-pull plate remains behind within the fuel cartridge case 80. When the push-pull plate 84 remains behind, the push-pull plate 84 slides in the direction toward the back wall 80A due to biasing force from the coil spring that is provided to the take-up shaft 72, and the water absorbing sheet 70 is wound up on the take-up shaft 72, as shown in FIG. 8A.

In this manner, the water absorbing sheet 70 may be opened out in the planar state along the surface of the cathode 18 simply by replacing the fuel cartridge 22, and water that has been generated on the surface of the cathode 18 may thereby be removed.

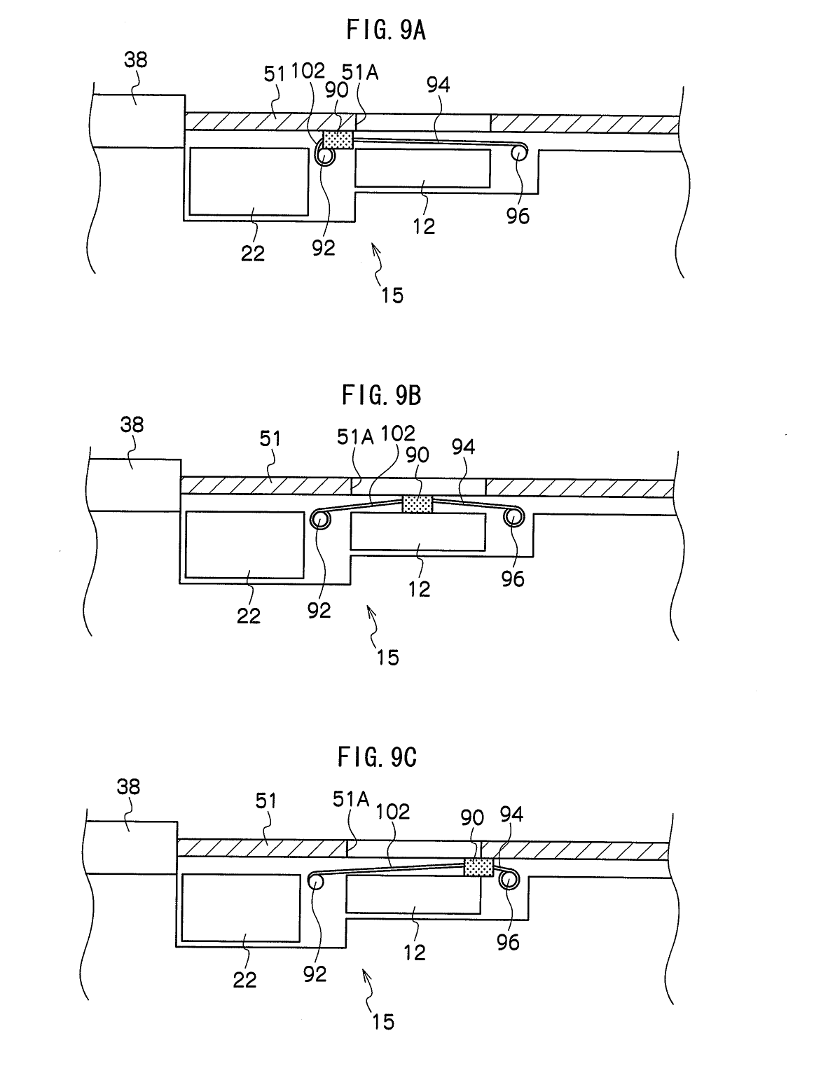

Explanation will now be given of a mobile phone 30 employing a fuel cell device 15 according to a fourth exemplary embodiment of the present invention, with reference to FIGS. 9A to 12B.

It should be noted that similar components to those of the first exemplary embodiment are allocated the same reference numerals, and explanation thereof is omitted

In this exemplary embodiment there is a rectangular cross-section water absorbing block 90 provided between the fuel cell 12 and the fuel cartridge 22, as shown in FIG. 9A, instead of the water absorbing block 26 attached to the rear face of the shutter member 40 of the first exemplary embodiment.

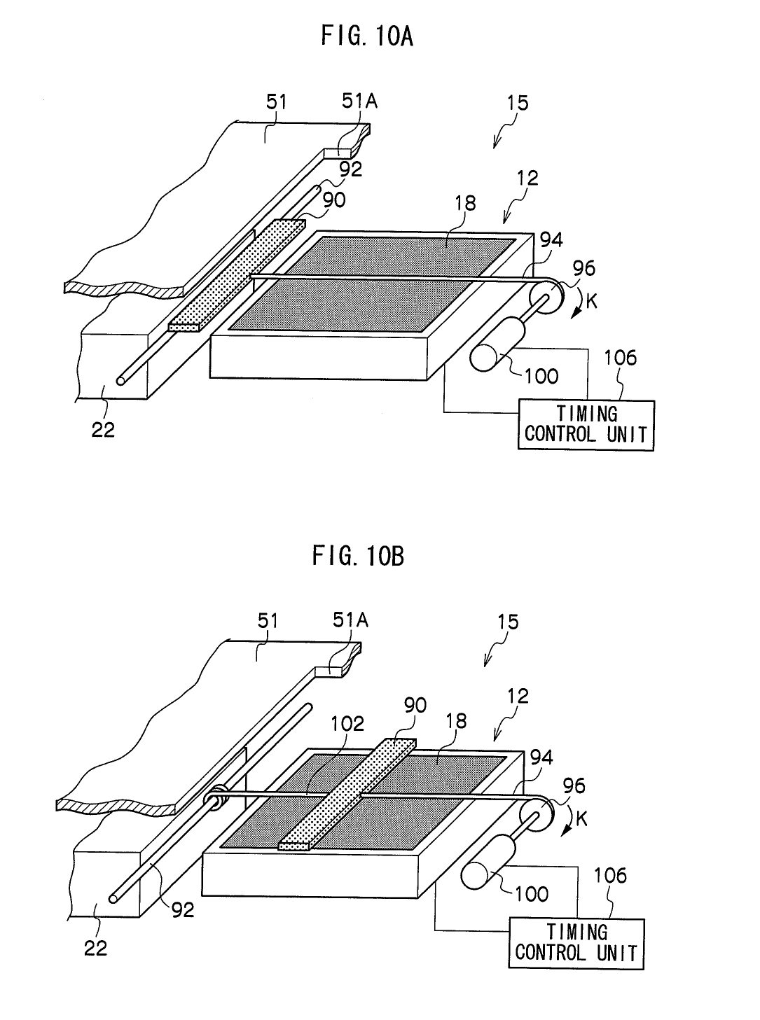

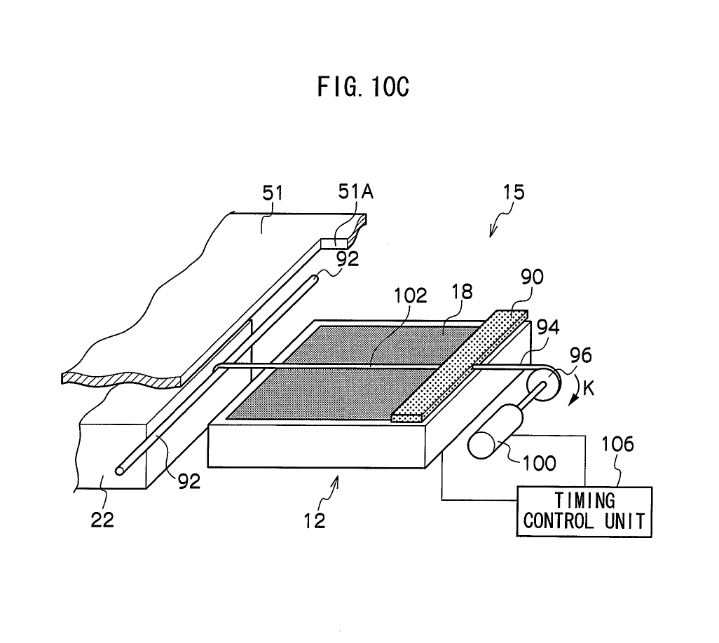

One end of a wire 94 is attached to one side of the water absorbing block 90 (the side that faces the fuel cell 12), as shown in FIGS. 9A and 10A, and the other end of the wire 94 is fixed to a pulley 96 that is provided in a position facing the water absorbing block 90 with the fuel cell 12 positioned therebetween. The pulley 96 is rotatably supported by a non-illustrated bracket, and there is a motor 100 provided at one end of a rotational shaft 98 of the pulley 96. There is also a timing control unit 106 provided in the fuel cell device 15 for controlling the rotation of the motor 100.

One end of a wire 102 is attached at the other side of the water absorbing block 90, as shown in FIGS. 9B and 10B, and the other end of the wire 102 is wrapped around a rod 92 that is provided between the fuel cell 12 and the fuel cartridge 22. There is a non-illustrated coil spring provided to the rod 92, for biasing the water absorbing block 90 to be disposed above the rod 92. The water absorbing block 90 is thereby biased to above the rod 92 in a state in which there is no external force acting. Both sides of the fuel cell 12 are each provided with guide members (omitted in the figures) that guide the two edge portions of the water absorbing block 90 moving due to the wire 94.

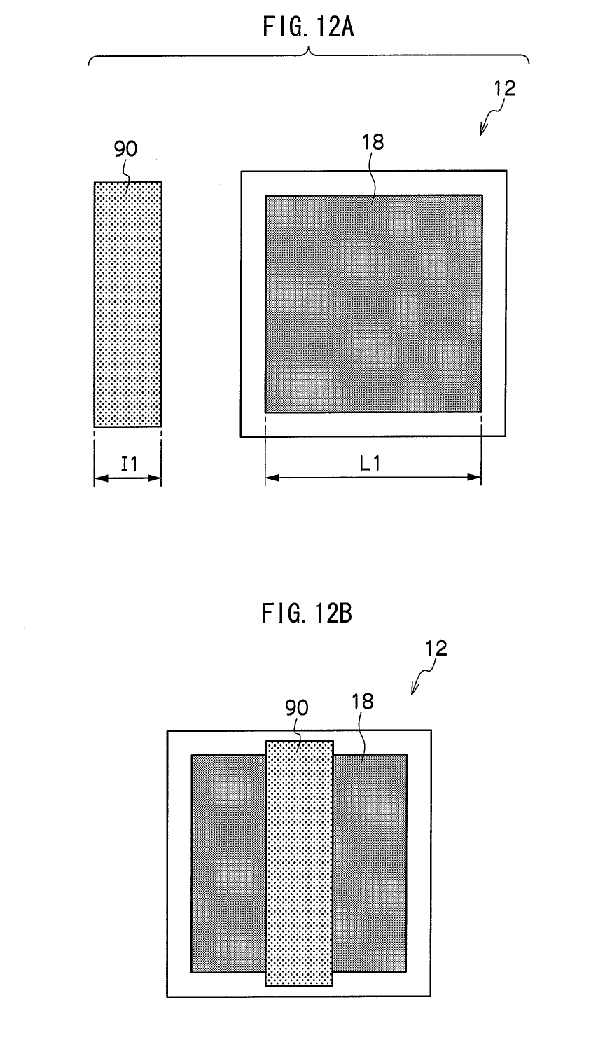

As shown in FIG. 12A, the length of the water absorbing block 90 in the conveying direction (the dimension shown as I1 in FIG. 12A) is shorter than the length of the cathode 18 (the dimension shown as L1 in FIG. 12A), such that the water absorbing block 90 does not cover the entire surface of the cathode 18 at any one time, as shown in FIG. 12B.

The fuel cell 12, fuel cartridge 22 and the water absorbing block 90 are covered by the cover 51, and there is an opening portion 51A formed in the cover 51 at a position that faces the fuel cell 12 such that air can be taken in.

Explanation will now be given of the movement of the water absorbing block 90 for removing water that has accumulated on the surface of the cathode 18.

In a state in which there is no rotational force load applied by the motor 100, as shown in FIGS. 9A and 10A, the water absorbing block 90 is disposed above the rod 92 by biasing force of the coil spring.

When the timing control unit 106 rotates the motor 100 in the direction of arrow K, as shown in FIGS. 9B and 10B, and the pulley 96 winds up the wire 94, the water absorbing block 90 slides along the surface of the cathode 18, while being guided by the guide members, absorbing and removing water therefrom.

When the water absorbing block 90 slides along the surface of the cathode 18 and passes the entire surface of the cathode 18, as shown in FIGS. 9C and 10C, the timing control unit 106 releases the motor 100 load and stops the water absorbing block 90.

When the load is released from the motor 100, the rod 92 winds up the wire 102 due to biasing force of the coil spring provided to the rod 92, and the water absorbing block 90 is returned to the initial position, as shown in FIGS. 9A and 10A. It should be noted that the movement duration during which the water absorbing block 90 slides and removes water from the surface of the cathode 18 is preferably 1 second or shorter, in consideration of the supply of air to the cathode 18.

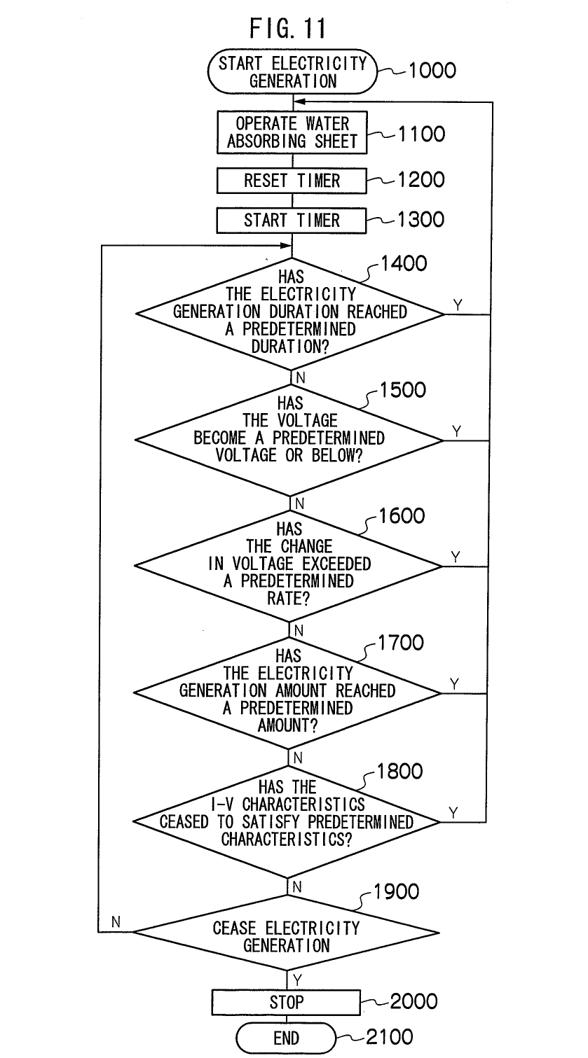

Explanation will now be given, with reference to FIG. 11, of the timing with which the timing control unit 106 rotates the motor 100 and slides the water absorbing block 90 along the surface of the cathode 18.

A user first switches on the mobile phone 30, and, at step 1000, electricity generation of the fuel cell device 15 is initiated, and the routine proceeds to step 1100.

At step 1100, the timing control unit 106 rotates the motor 100, and slides the water absorbing block 90 along the surface of the cathode 18, then the load of the motor 100 is released, and the water absorbing block 90 is returned to the initial position so that water absorbing movement is carried out. When the water absorbing movement is completed, the routine proceeds to step 1200.

At step 1200, a timer provided within the timing control unit 106 for managing the electricity generation duration is reset. At step 1300, the timer is started, and the routine proceeds to step 1400.

At step 1400, when the electricity generation duration has reached a predetermined duration, the routine proceeds to step 1100, and water absorbing movement is carried out, and when the electricity generation duration has not reached the predetermined duration, the routine proceeds to step 1500.

When the fuel cell 12 generates electricity at 0.75V and the current density is 0.3 A/cm², the amount of water generated for each 1 cm² is 1.68 μl/min. If it is supposed that all of this generated water accumulates at the surface of the cathode 18, then there is a water film with a thickness of 0.5 mm formed after 30 minutes, and this leads to impaired air diffusion. In reality not all of the generated water accumulates at the surface of the cathode 18 due to diffusion toward the anode 16 and to evaporation, but a reduction occurs in the voltage after about 30 minutes due to impaired air diffusion. Therefore, the water absorbing block 90 may be operated every 10 to 60 minutes, and preferably every 20 to 40 minutes, after starting electricity generation.

At step 1500, the timing control unit 106 detects the voltage of the fuel cell 12, and when the detected voltage has become a predetermined voltage or below, the routine proceeds to step 1100 and water absorbing movement is carried out, and when the voltage is higher than this predetermined voltage, the routine proceeds to step 1600.

Usually when the voltage of the fuel cell 12 is 0.3 V or above, then the voltage varies in proportion to the current value, however, when the voltage becomes 0.3 V or below, then the voltage varies not in proportion to the current value due to the air diffusion control, and a sudden reduction in the voltage occurs. Therefore, the water absorbing block 90 may be operated when the voltage of the fuel cell 12 is 0.2 V to 0.5 V or below, and preferably when 0.25 V to 0.4 V or below.

At step 1600, the timing control unit 106 detects the change in voltage of the fuel cell 12, and when the change in voltage detected has exceeded a predetermined rate, the routine proceeds to step 1100 and water absorbing movement is carried out, and when the change in voltage has not exceeded the predetermined rate, the routine proceeds to step 1700.

The change in the voltage during a given duration becomes greater than 0.1 V/min usually when a sudden change in the load occurs and when it is difficult to maintain the voltage of the fuel cell 12 due to the air diffusion control. Therefore, the water absorbing block 90 may be operated when the change in voltage has become 0.05 to 2.0 V/min or above, and preferably 0.08 to 1.2 V/min or above.

At step 1700, the timing control unit 106 detects the electricity generation amount of the fuel cell 12, and when the electricity generation amount has reached a predetermined amount, the routine proceeds to step 1100 and water absorbing movement is carried out, and when the electricity generation amount is less than this predetermined amount, the routine proceeds to step 1800.

For example, when a single cell generates electricity at 0.75V and the current density is 0.3 A/cm², then the electricity output amount from 30 minutes of electricity generation is 0.112 Wh/cm². With such a electricity output amount as the standard, even when the current density is different from the values given before, the water absorbing block 90 may be operated at every time when the electricity output amount is 0.04 to 0.23 Wh/cm², and preferably 0.08 to 0.15 Wh/cm².

At step 1800, the timing control unit 106 detects the current and voltage characteristics, and when predetermined current and voltage characteristics are not satisfied, then the routine proceeds to step 1100 and water absorbing movement is carried out, and when the predetermined current and voltage characteristics are satisfied, then the routine proceeds to step 1900.

It is usual for the fundamental characteristics of the fuel cell 12 (current and voltage characteristics) to be measured when the fuel cell 12 is connected to a device. When the performance of the fuel cell 12 during electricity generation falls below these fundamental characteristics, then there is a chance that impaired air diffusion is occurring. Therefore, the water absorbing block 90 may be operated when the cell performance (the voltage value for a given current value) falls 0 to 30%, and preferably 0 to 15%, below the fundamental characteristics that have been measured in advance.

At step 1900, if the power of the mobile phone 30 is switched on, then the routine returns to step 1400, and timing control unit 106 monitors the various characteristics and water absorbing movement is carried out, and if the power of the mobile phone 30 is not switched on, then the routine proceeds to step 2000, electricity generation is ceased, and the routine ends at step 2100.

Water may be periodically wiped from the surface of the cathode 18 since the timing control unit 106 actuates the motor 100 at predetermined electricity generation intervals in this manner.

The voltage of the fuel cell 12 may be prevented from becoming a predetermined voltage or lower since the timing control unit 106 also actuates the motor 100 when the voltage of the fuel cell 12 has become a predetermined voltage or lower, and the frequency with which water absorbing movement is carried out may be reduced.

The change in voltage of the fuel cell 12 may be suppressed and stable supply of electricity may be carried out since the timing control unit 106 also actuates the motor 100 when the change in voltage of the fuel cell 12 exceeds a predetermined rate, and the frequency with which water absorbing movement is carried out may be reduced.

Water that has been generated according to the electricity generation amount may be efficiently wiped away since the timing control unit 106 also actuates the motor 100 each time for a predetermined amount of electricity generation.

Electricity may be supplied that satisfies predetermined current and voltage characteristics since the timing control unit 106 also actuates the motor 100 when the fuel cell 12 has ceased to satisfy predetermined current and voltage characteristics, and the frequency with which water absorbing movement is carried out may be reduced.

Air, acting as an oxidant, may be continuously supplied to the cathode 18 since the length of the water absorbing block 90 in the conveying direction is shorter than the length of the cathode 18 and so the water absorbing block 90 does not cover the entire surface of the cathode 18 at any one time.

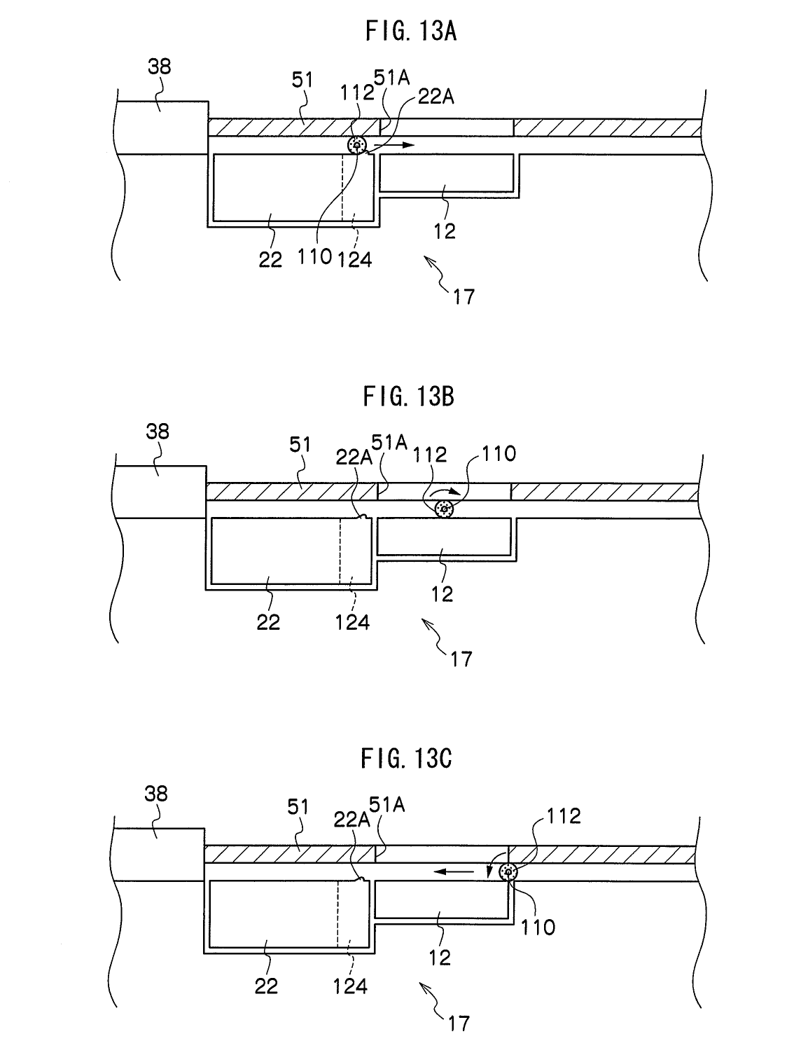

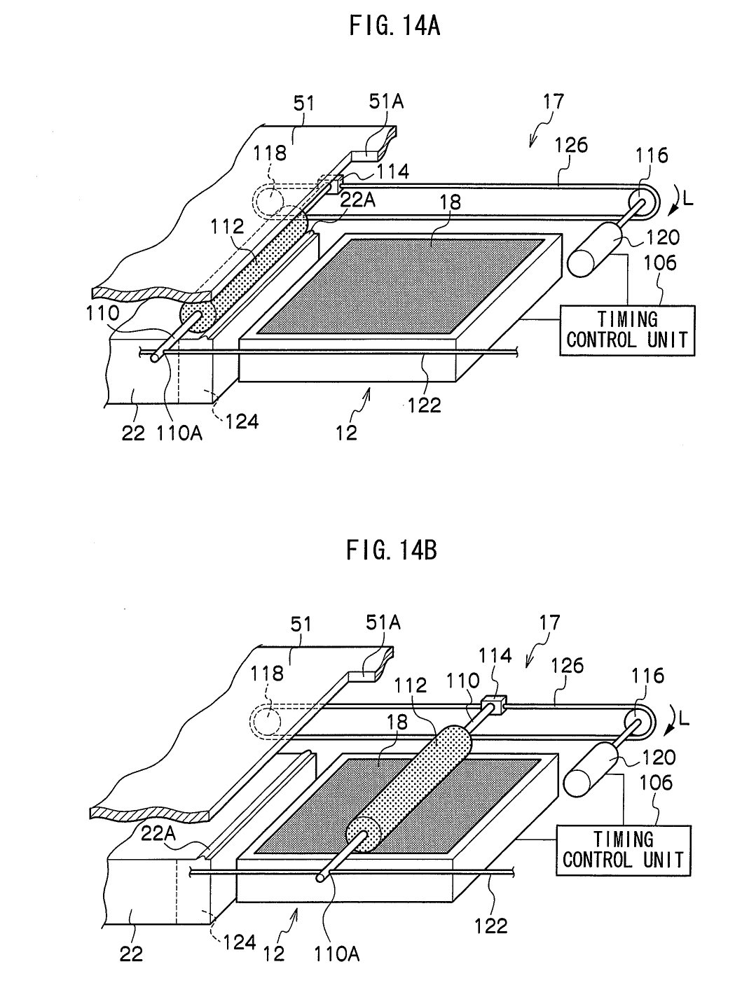

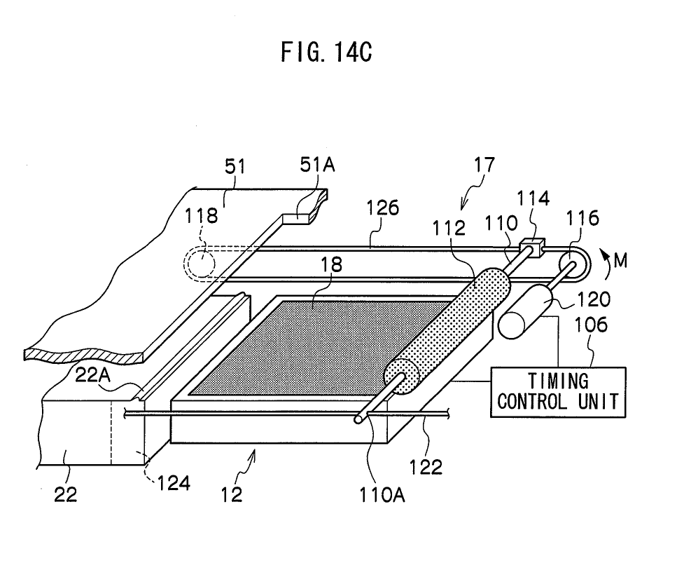

Explanation will now be given of a mobile phone 30 employing a fuel cell device 17 according to a fifth exemplary embodiment of the present invention, with reference to FIGS. 13A to 14C.

It should be noted that similar components to those of the fourth exemplary embodiment are allocated the same reference numerals, and explanation thereof is omitted.

In the present exemplary embodiment, as shown in FIG. 14A, there is no water absorbing block 90 provided as in the fourth exemplary embodiment, and in its place there is a water absorbing roll 112 that is rotatably supported by an axial member 110, and is disposed at the top surface of the fuel cartridge 22.

There is a rectangular parallelepiped fixing member 114 provided at one end of the axial member 110, and the fixing member 114 is fixed to an endless belt 126 that is entrained around a pulley 116 and a pulley 118 that are provided so that the fuel cell 12 is disposed therebetween. There is a motor 120 mounted to the rotational axis of the pulley 116.

There is also a through hole 110A provided at the other end of the axial member 110, and a rod 122 that is provided parallel to the endless belt 126 passes through the through hole 110A. The axial member 110 is thereby able to move along the rod 122.

There is a triangular cross-section squeeze protrusion portion 22A provided at the top surface of the fuel cartridge 22 adjacent to the water absorbing roll 112, as shown in FIG. 13A. There are water absorbing holes (omitted in the figures) provided to the surface of the squeeze protrusion portion 22A, and a porous member 124 is also provided within the fuel cartridge 22, for absorbing water that has entered into the fuel cartridge 22 from the water absorbing holes.

Explanation will now be given of the movement of the water absorbing roll 112 for removing water that has accumulated on the surface of the cathode 18.

In an initial state in which there is no rotational force load applied to the motor 120, as shown in FIGS. 13A and 14A, the water absorbing roll 112 is disposed at the top surface of the fuel cartridge 22.

As shown in FIGS. 13B and 14B, the timing control unit 106 rotates the motor 120 in the direction of arrow L with a predetermined timing, and when the pulley 116 is rotated, the endless belt 126, which is entrained around the pulleys 116, 118, also rotates.

The axial member 110, which has one end mounted to the endless belt 126 via the fixing member 114 and has the other end movable along the rod 122, moves toward the pulley 116 by the rotation of the endless belt 126, and the water absorbing roll 112 is thereby moved by rolling over the surface of the cathode 18.

As shown in FIGS. 13C and 14C, when the water absorbing roll 112 rolls along the surface of the cathode 18 and passes the entire surface of the cathode 18, the timing control unit 106 rotates the motor 120 in the opposite direction, the direction of arrow M, and the water absorbing roll 112 is rolled toward the fuel cartridge 22. When the water absorbing roll 112 returns to the initial position shown in FIGS. 13A and 14A, the timing control unit 106 stops the motor 120, and the water absorbing roll 112 has been returned to the initial position and is ready for the next movement thereof.

Here, when the water absorbing roll 112 is returned to the initial position, the surface of the water absorbing roll 112 is pressed by the squeeze protrusion portion 22A, and water that has been absorbed is comes out from the surface of the water absorbing roll 112. This water that has come out from the surface passes through the water absorbing holes that have been provided in the squeeze protrusion portion 22A and is collected in by the porous member 124 that has been provided within the fuel cartridge 22.

The water that has been generated on the surface of the cathode 18 may be removed in this manner by rolling the water absorbing roll 112 along the surface of the cathode 18.

In addition, since the porous member 124 collects the water that has been absorbed by the water absorbing roll 112, the water absorbing roll 112 may sufficiently remove water that has been generated on the surface of the cathode 18, even when the water absorbing roll 112 is used the next time.

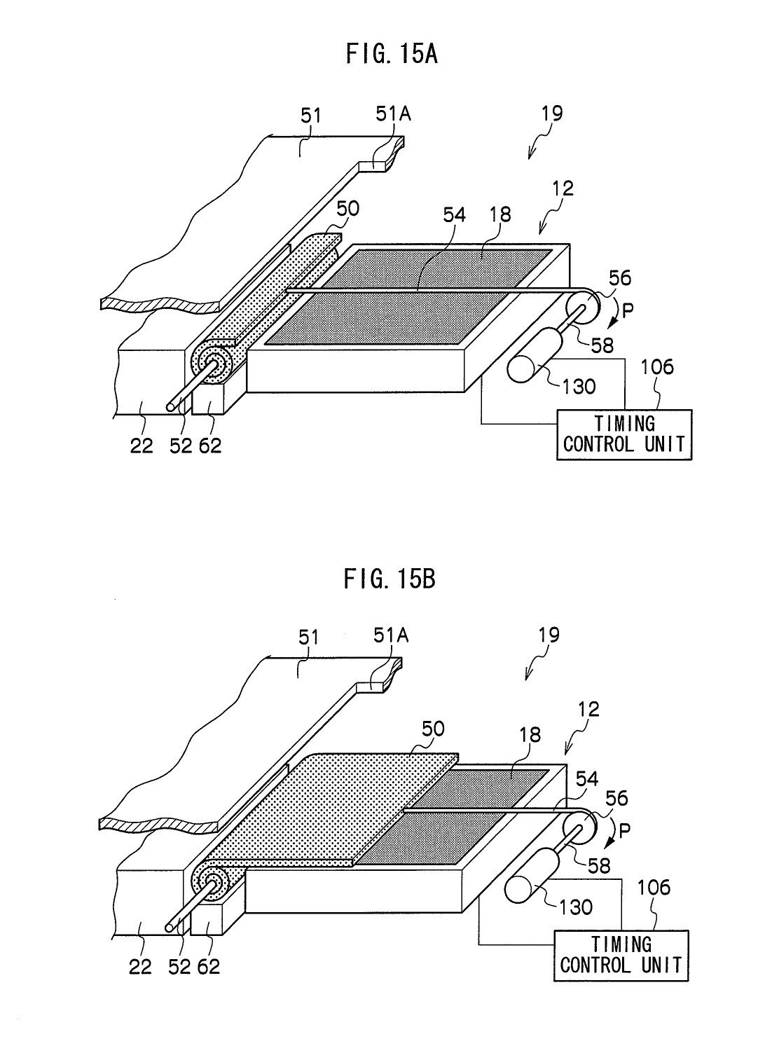

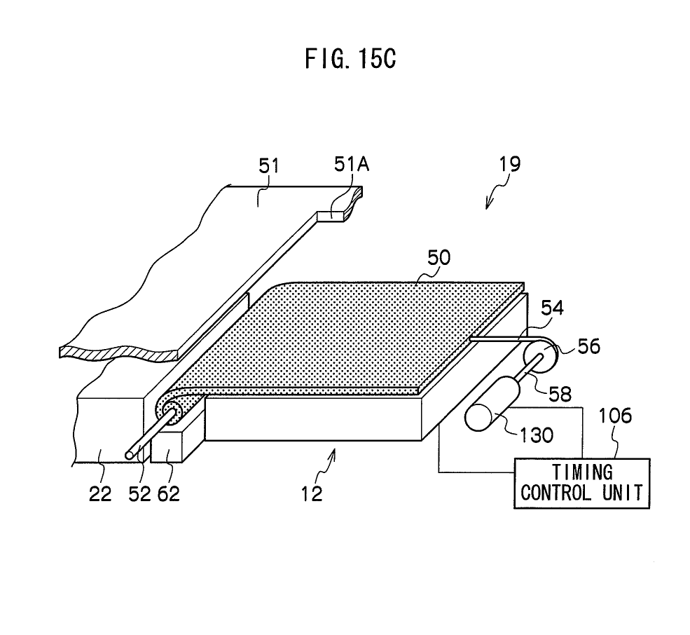

Explanation will now be given of a mobile phone 30 employing a fuel cell device 19 according to a sixth exemplary embodiment of the present invention, with reference to FIGS. 15A to 15C.

It should be noted that similar components to those of the second exemplary embodiment are allocated the same reference numerals, and explanation thereof is omitted.

In the present exemplary embodiment, as shown in FIG. 15A, there is no dial 60 provided at one end of the rotational shaft 58 of the pulley 56 as in the second exemplary embodiment, and instead there is motor 130 provided that is controlled by the timing control unit 106.

Explanation will now be given of the movement of the water absorbing sheet 50 for removing water that has accumulated on the surface of the cathode 18.

In an initial state in which there is no rotational force load applied to the motor 130, as shown in FIG. 15A, the water absorbing sheet 50 is in a state of being wrapped up around the take-up shaft 52 by biasing force of a coil sprint that is provided to the take-up shaft 52.

As shown in FIG. 15B, the timing control unit 106 rotates the motor 130 in the direction of arrow P at a predetermined timing, and the pulley 56 winds up the wire 54.

When the pulley 56 winds up the wire 54, the water absorbing sheet 50 that is attached to one end of the wire 54 is moved and opened out into a planar state along the surface of the cathode 18 while being guided by guide members.

When the water absorbing sheet 50 has been opened out into a planar state and covers the entire surface of the cathode 18, as shown in FIG. 15C, the timing control unit 106 releases the load of the motor 130, and the water absorbing sheet 50 is wound up on the take-up shaft 52 by biasing force of a coil spring provided to the take-up shaft 52, as shown in FIG. 15A.

The water that has been generated on the surface of the cathode 18 may be removed in this manner by the motor 130 opening out the water absorbing sheet 50 into a planar state along the surface of the cathode 18.

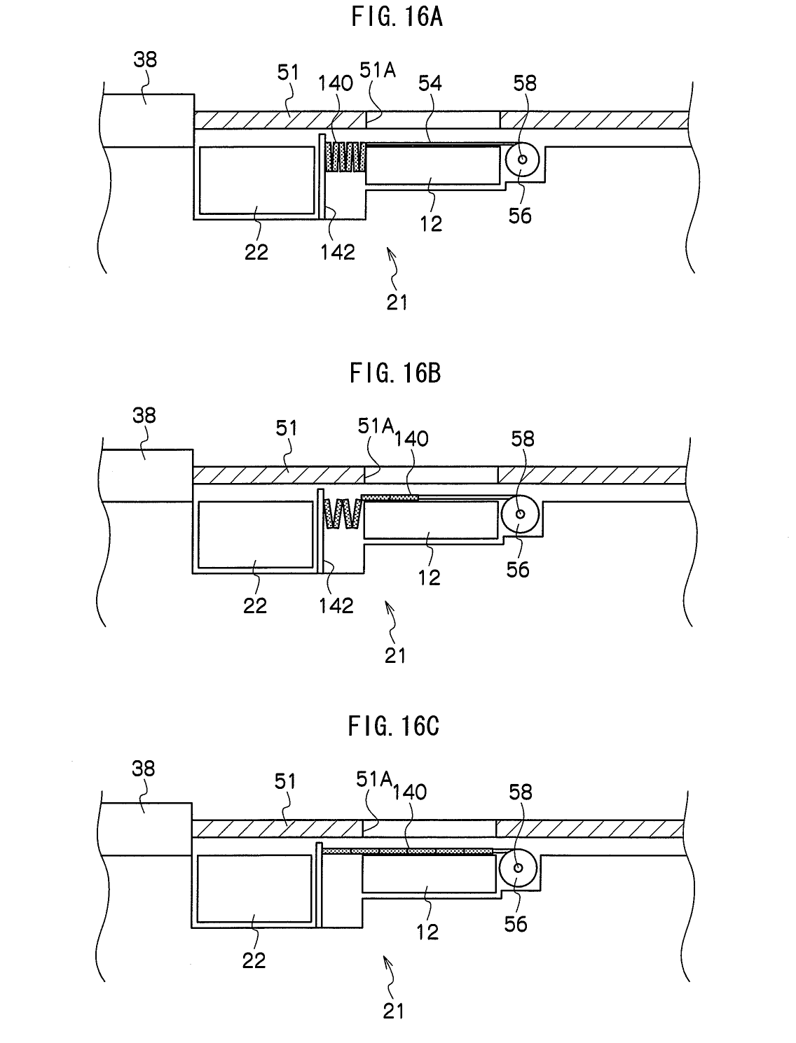

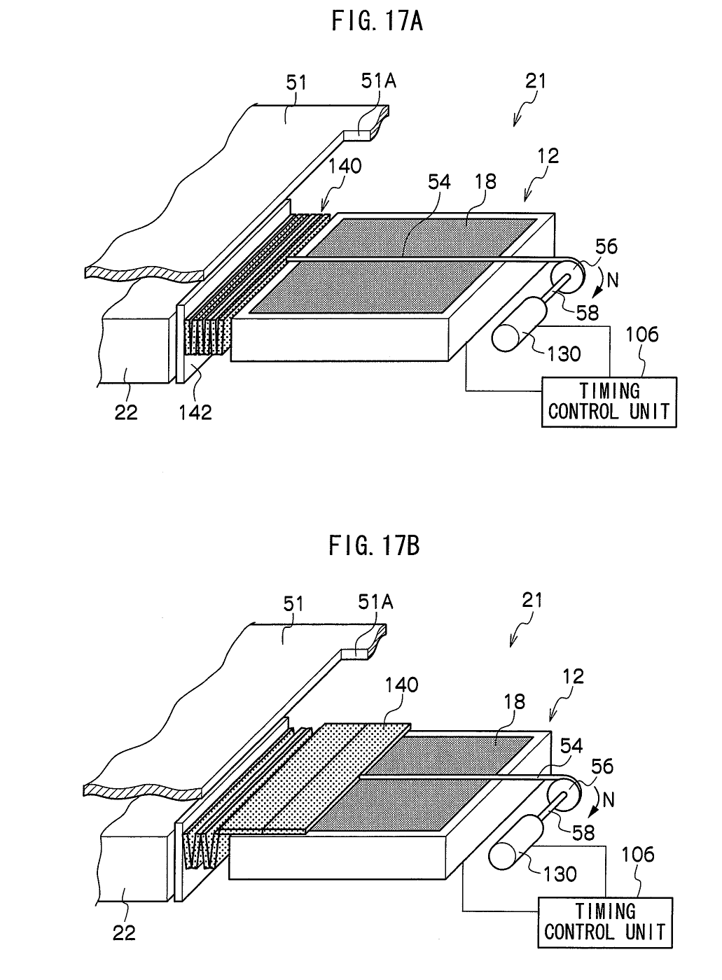

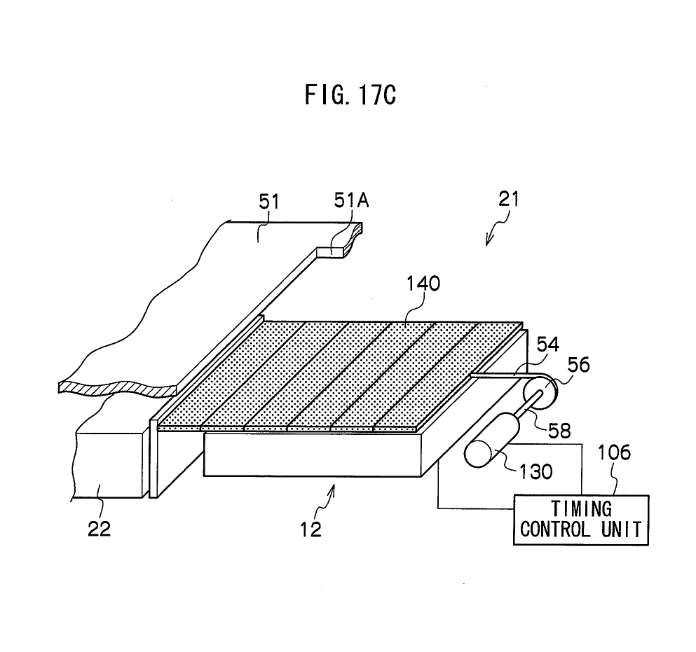

Explanation will now be given of a mobile phone 30 employing a fuel cell device 21 the according to a seventh exemplary embodiment of the present invention, with reference to FIGS. 16A to 17C.

It should be noted that similar components to those of the sixth exemplary embodiment are allocated the same reference numerals, and explanation thereof is omitted.

In the present exemplary embodiment, as shown in FIGS. 16A and 17A, the water absorbing sheet 50 is not wound up on the take-up shaft 52 as in the sixth exemplary embodiment, but instead a water absorbing sheet strip 140 is folded up in a zig-zag shape between the fuel cell 12 and the fuel cartridge 22.

There are zig-zag shaped memory wires (omitted in the figures) provided to both edges of the water absorbing sheet strip 140, and there are rods (omitted in the figures) provided at the folds of the zig-zag shape, the rods spanning across the width direction of the water absorbing sheet strip 140. By such a configuration, the water absorbing sheet strip 140 folds up into a zig-zag shape in a state in which there is no external force applied to the water absorbing sheet strip 140.

There are guide rails (omitted in the figures) provided at both edge portions of the fuel cell 12 for opening the water absorbing sheet strip 140 out over the surface of the cathode 18. One end of the water absorbing sheet 140 is fixed to one end of a wire 54, and the other end of the water absorbing sheet strip 140 is attached to a wall portion 142 that stands erect on the fuel cartridge 22 side. The water absorbing sheet strip 140 moves toward a pulley 56 and is opened out into a planar state along the surface of the cathode 18 when the water absorbing sheet strip 140 is pulled by the wire 54.

Explanation will now be given of the movement of the water absorbing sheet strip 140 for removing water that has accumulated on the surface of the cathode 18.

In an initial state in which there is no rotational force load applied to the motor 130, as shown in FIGS. 16A and 17A, the water absorbing sheet strip 140 is folded up between the fuel cell 12 and the fuel cartridge 22 in a zig-zag shape by biasing force of the memory wires.

As shown in FIGS. 16B and 17B, the timing control unit 106 rotates the motor 130 in the direction of arrow N at a predetermined timing, and the pulley 56 winds up the wire 54.

By the pulley 56 winding up the wire 54, the water absorbing sheet strip 140 that is attached to one end of the wire 54 is moved toward the pulley 56 while being gradually opened out, from the zig-zag shape folded end portion, into a planar state along the surface of the cathode 18

When the water absorbing sheet strip 140 is opened out into a planar state and covers the entire surface of the cathode 18, as shown in FIGS. 16C and 17C, the timing control unit 106 releases the load of the motor 130. When the load of the motor 130 is released, the water absorbing sheet strip 140 is folded up into a zig-zag shape between the fuel cell 12 and the fuel cartridge 22, as shown in FIG. 17A, by biasing force of the zig-zag shaped memory wires provided at both edges of the water absorbing sheet strip 140.

The water that has been generated on the surface of the cathode 18 may be removed in this manner by the motor 130 opening out the zig-zag shaped water absorbing sheet strip 140 in a planar state along the surface of the cathode 18.

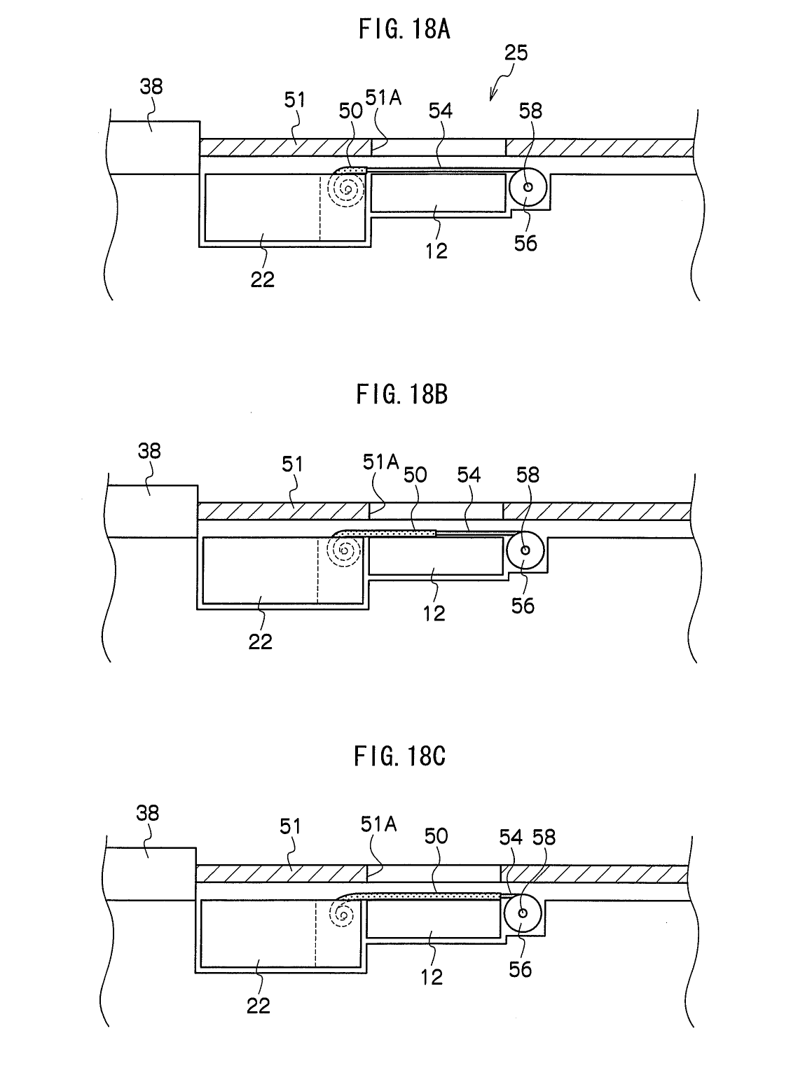

Explanation will now be given of a mobile phone 30 employing a fuel cell device 25 according to an eighth exemplary embodiment of the present invention, with reference to FIGS. 18A to 18C.

It should be noted that similar components to those of the sixth exemplary embodiment are allocated the same reference numerals, and explanation thereof is omitted.

In the present exemplary embodiment the water absorbing sheet 50 is not provided between the fuel cartridge 22 and the fuel cell 12 as in the sixth exemplary embodiment, but instead the water absorbing sheet 50 is provided within the fuel cartridge 22, as shown in FIG. 18A.

Thereby, when the fuel cartridge 22 is replaced, the water absorbing sheet 50 is also replaced therewith.

Removal of the water from the surface of the cathode 18 with the water absorbing sheet 50, as shown in FIGS. 18A and 18C, is similar to that of the sixth exemplary embodiment, except that one end portion of the wire 54 that is attached to the pulley 56 is attached to an engaging portion (omitted in the figures) provided at an edge portion of the water absorbing sheet 50 when mounting to the fuel cartridge 22.

By providing the water absorbing sheet 50 within the fuel cartridge 22 in such a manner, the water absorbing sheet 50 may be replaced at the same time as replacing the fuel cartridge 22, therefore saving the effort of replacing the water absorbing sheet 50 only.

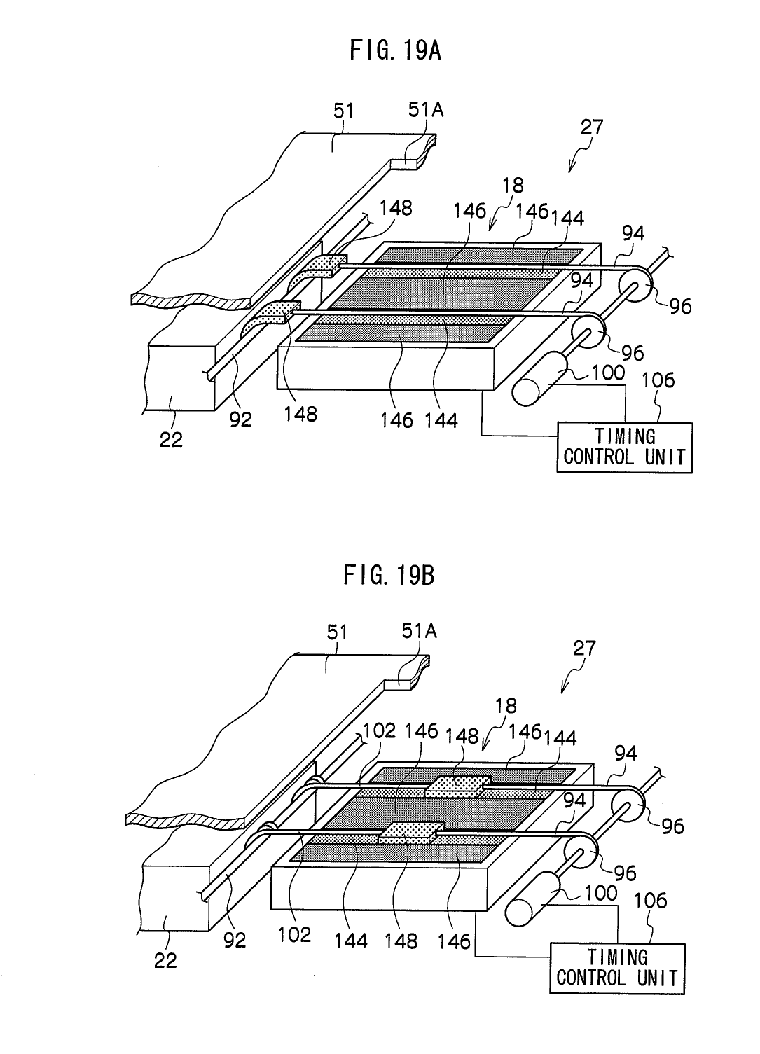

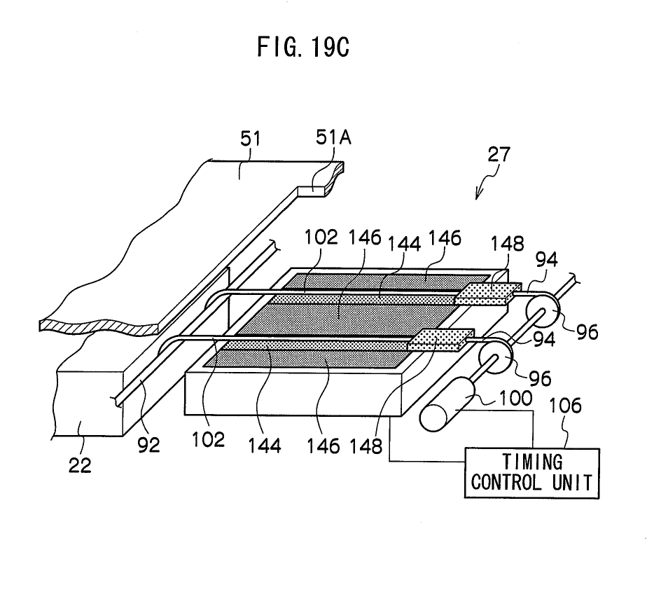

Explanation will now be given of a mobile phone 30 employing a fuel cell device 27 according to a ninth exemplary embodiment of the present invention, with reference to FIGS. 19A to 19C.

It should be noted that similar components to those of the fourth exemplary embodiment are allocated the same reference numerals, and explanation thereof is omitted.

In the present exemplary embodiment, in contrast to in the fourth exemplary embodiment, there are two hydrophilic portions 144 treated with a hydrophilic coating having hydrophilic properties, and three hydrophobic portions 146 treated with a hydrophobic coating having hydrophobic properties, provided along the conveying direction of a water absorbing member on the surface of the cathode 18, as shown in FIG. 19A. The hydrophilic portions 144 and the hydrophobic portions 146 are disposed alternately to each other. Thereby the water that has been generated on the surface of the cathode 18 is repelled by the hydrophobic portions 146 and accumulates on the hydrophilic portions 144.

In addition, water absorbing blocks 148 are not provided so as to span across the entire width of the cathode 18, but are provided in positions that corresponds to that of the two hydrophilic portions 144. There are also two pulleys 96 provided corresponding to the two water absorbing blocks 148.

Removal of water from the surface of the cathode 18 by the water absorbing blocks 148 as shown in FIGS. 19A to 19C is similar to that of the fourth exemplary embodiment, except that the two water absorbing blocks 148 wipe off water that has accumulated on the two hydrophilic portions 144.

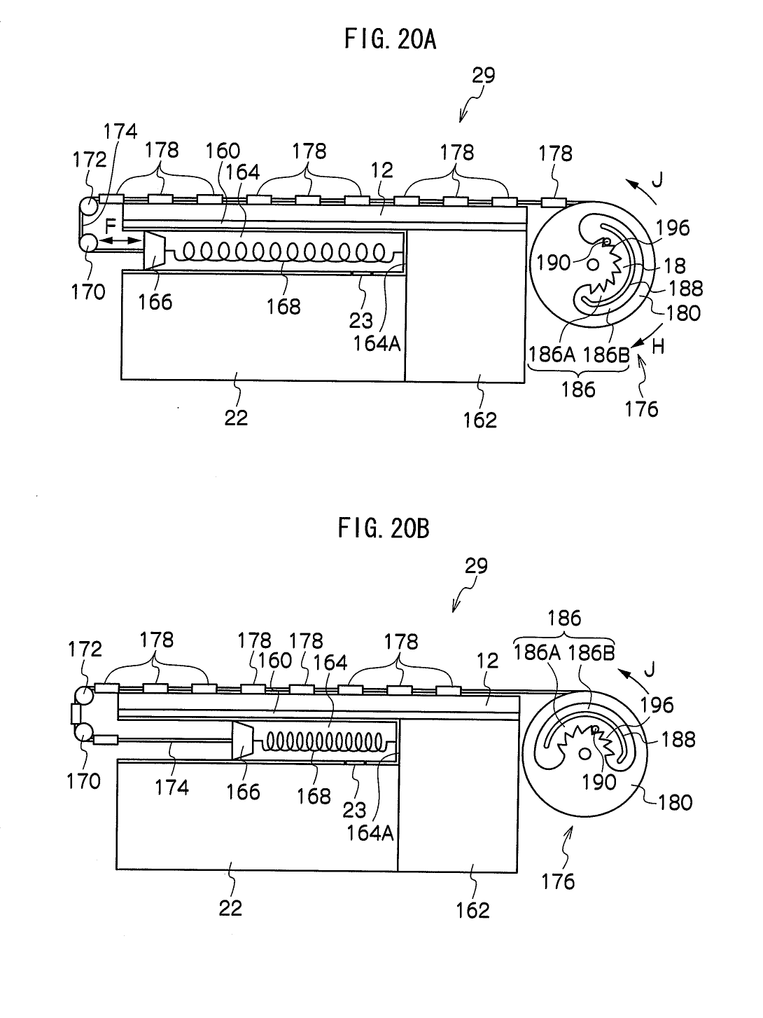

Explanation will now be given of a mobile phone 30 employing a fuel cell device 29 according to a tenth exemplary embodiment of the present invention, with reference to FIGS. 20A to 23.

It should be noted that similar components to those of the seventh exemplary embodiment are allocated the same reference numerals, and explanation thereof is omitted.

In the present exemplary embodiment the fuel cartridge 22 is not disposed to the fuel cell 12 side as in the seventh exemplary embodiment, but instead the fuel cartridge 22 is disposed below the fuel cell 12, as shown in FIG. 20A.

Furthermore, there is a second fuel chamber 160, for supplying fuel to the fuel cell 12, provided along the bottom face of the fuel cell 12 between the fuel cell 12 and the fuel cartridge 22, and a rectangular parallelepiped circuit box 162 is provided below the second fuel chamber 160.

There is also a first fuel chamber 164, for supplying fuel taken from the fuel cartridge 22 to the second fuel chamber 160, provided so as to be surrounded by the second fuel chamber 160, the fuel cartridge 22 and the circuit box 162.

The top face of the fuel cartridge 22 is also provided with a suction valve 23 that opens when the internal pressure of the first fuel chamber 164 suddenly reduces, and supplies fuel taken from the fuel cartridge 22 to the first fuel chamber 164.

There is also a piston 166, for closing off and sealing an opening portion of the first fuel chamber 164, provided to the opening portion of the first fuel chamber 164. The piston 166 is attached so as to be able to slide in the direction that increases-decreases the volume of the first fuel chamber 164 (the directions shown by arrow F in FIG. 20A), and there is a coil spring 168 provided, with one end thereof attached to a bottom wall 164A of the first fuel chamber 164 and the other end thereof attached to the internal wall of the piston 166. By such a configuration, the piston 166 is biased in the direction toward the bottom wall 164A by biasing force of the coil spring 168.

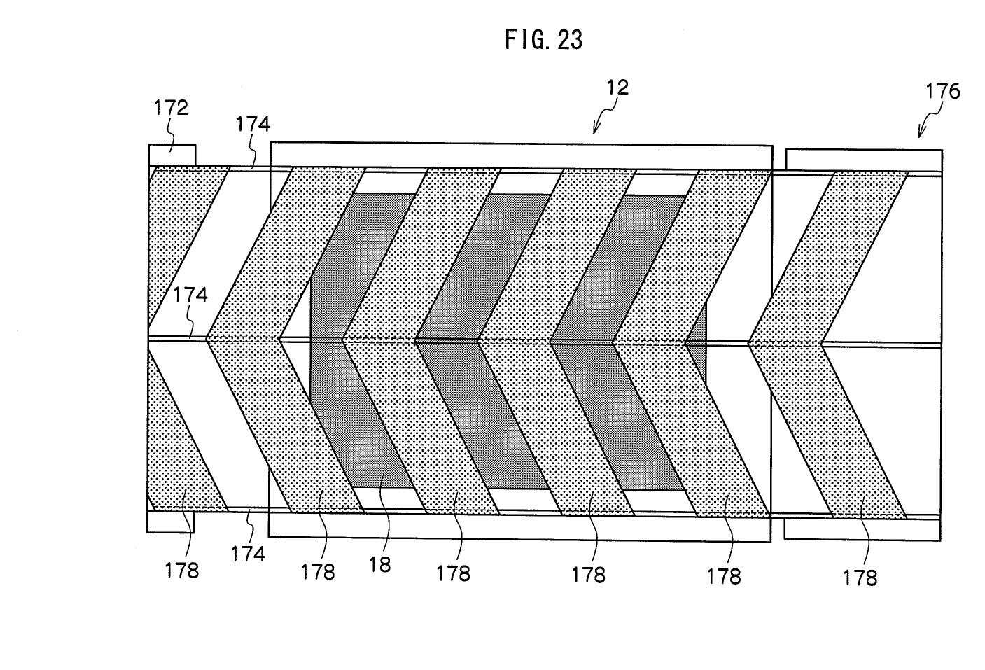

One end portions of three wires 174 (see FIG. 23), which are entrained around a fixed pulley 170 provided to the side of the piston 166 and a fixed pulley 172 provided above the fixed pulley 170, are attached to the external wall of the piston 166.

The other end portions of the three wires 174 are entrained around the fixed pulleys 170, 172 and along the top surface of the fuel cell 12 and fixed so as to be entrained around a roll shaped wheel 176 that is on the opposite side of the fuel cell 12 to the fixed pulleys 170, 172.

The three wires 174 are provided at even intervals, as shown in FIG. 23, and there are V shaped water absorbing sheets 178 provided at even intervals, attached to the wires 174 at both edge portions and at the central portions of the water absorbing sheets 178. The water absorbing sheets 178 that are fixed to the wires 174 move along the surface of the cathode 18 when the wires 174 move toward the fixed pulley 172 from the wheel 176, and water is wiped off that has accumulated on the surface of the cathode 18.

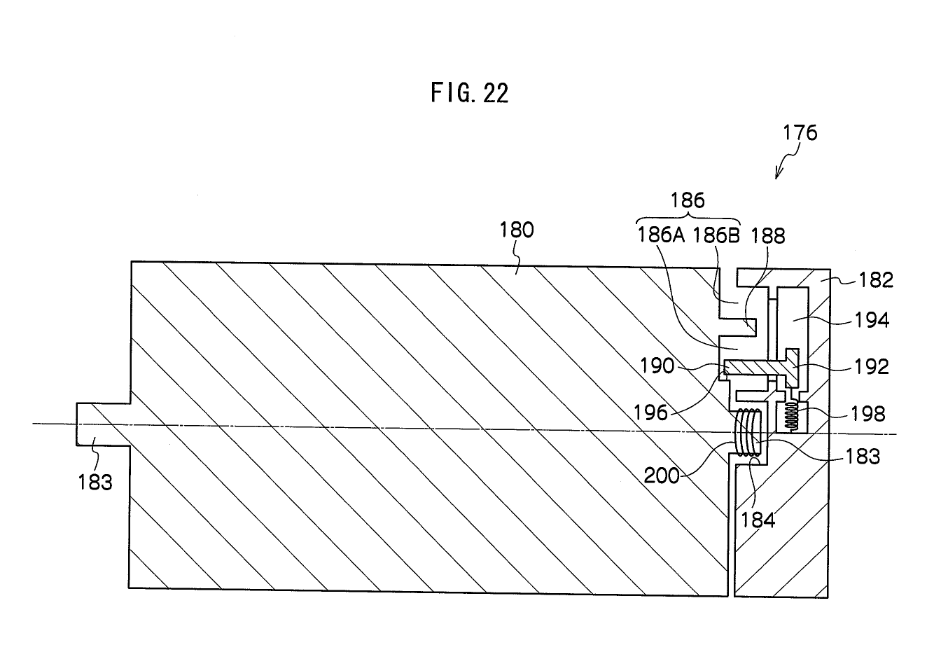

The wheel 176 is provided with a rotating roll portion 180 and a fixed wheel body 182, and there is an axial portion 183 projecting out from the end portions on both sides of the roll portion 180, as shown in FIG. 22. The axial portion 183 at one end is rotatably supported by a non-illustrated frame member, and the axial portion 183 at the other end is rotatably supported by an axial receiving portion 184 that is provided to the wheel body 182.

There is a torsion coil spring 200 provided at the axial portion 183 that is supported by the axial receiving portion 184, and the roll portion 180 is biased by biasing force of the torsion coil spring 200 in a clockwise direction (the direction shown by arrow H in FIG. 20A). Thereby, the wires 174 move so there is an equilibrium of force of the torsion coil spring 200 biasing the roll portion 180 in a clockwise direction, force of the coil spring 168 biasing the piston 166 toward the bottom wall 164A, and force of the internal pressure of the first fuel chamber 164.

In the present exemplary embodiment, as shown in FIG. 20A, the spring forces of each of the springs are determined such that when there is sufficient fuel filled in the first fuel chamber 164, and the piston 166 is in the position with the volume of the first fuel chamber 164 at its maximum, biasing force of the torsion coil spring 200, biasing force of the coil spring 168 and the internal pressure of the first fuel chamber 164 balance each other.

There is also a grooved portion 186, of a curved shape when viewed from the side, that is provided to the roll portion 180 facing the wheel body 182, as shown in FIGS. 20A and 22. There is also a wall portion 188 provided so as to divide the grooved portion 186 into an internal groove portion 186A and an external groove portion 186B. It should be noted that there is no wall portion 188 provided at the two end portions of the internal groove portion 186A and the external groove portion 186B, and the internal groove portion 186A and the external groove portion 186B are in contact with each other at these end portions.

There is also a latch portion 196 with indented and protruding shapes provided to the inside of the internal groove portion 186A, and there is a circular cylinder shaped pin 190 provided to the wheel body 182 that engages with the latch portion 196.

The base portion 192 of the pin 190 is slightly larger in diameter than the main portion of the pin 190, and the base portion 192 is disposed so as to be able to move in a moving portion 194 that is provided to the wheel body 182, extending in a radial direction thereof.

There is also a coil spring 198, which extends in a radial direction, attached at the base portion 192, and the base portion 192 is biased toward the central line of the axial portion 183 by the coil spring 198, so that the pin 190 thereby meshes with the latch portion 196.

The teeth of the latch portion 196 that engage with the pin 190 are shaped such that when the roll portion 180 rotates in a clockwise direction (the direction shown by arrow H in FIG. 20A), the teeth mesh with the pin 190 and prevent rotation of the roll portion 180, and when the roll portion 180 rotates in an anti-clockwise direction (the direction shown by the arrow J in FIG. 20A), the meshing of the teeth with the pin 190 is released and the roll portion 180 is able to rotate.

Explanation will now be given of the movement of the water absorbing sheets 178 for removing water that has accumulated on the surface of the cathode 18.

In a state in which fuel is filled in the first fuel chamber 164, as shown in FIG. 20A, the piston 166 is disposed against biasing force of the coil spring 168 toward the outside (in the direction of separation from the bottom wall 164A) such that the volume of the first fuel chamber 164 becomes its maximum.

In this state, as stated above, the biasing force of the coil spring 200, the biasing force of the coil spring 168 and the internal pressure of the first fuel chamber 164 are in balance.

When the fuel cell 12 generates electricity, as shown in FIG. 20B, the fuel in the second fuel chamber 160 is consumed, and in addition, by the consumption of fuel in the second fuel chamber 160, fuel from the first fuel chamber 164 is supplied to the second fuel chamber 160.

The internal pressure of the first fuel chamber 164 is reduced by the supplying of fuel from the first fuel chamber 164, and the piston 166 moves toward the bottom wall 164A by biasing force of the coil spring 168. When the piston 166 moves, the wires 174 are pulled, and the water absorbing sheets 178 are moved along the surface of the cathode 18, and water that has accumulated on the surface of the cathode 18 is absorbed.

The engagement of the pin 190 with the latch portion 196 is released by the pulling of the wires 174 toward the fixed pulley 172, and the roll portion 180 rotates in an anti-clockwise direction (the direction shown by arrow J in FIG. 20B). At the position where biasing force of the coil spring 200, biasing force of the coil spring 168 and the internal pressure of the first fuel chamber 164 are in balance, the piston 166, the water absorbing sheets 178 and the roll portion 180 cease moving, and the pin 190 biased by the coil spring 198 engage with the latch portion 196. The pin 190 thereby prevents the roll portion 180 from rotating in a clockwise direction.

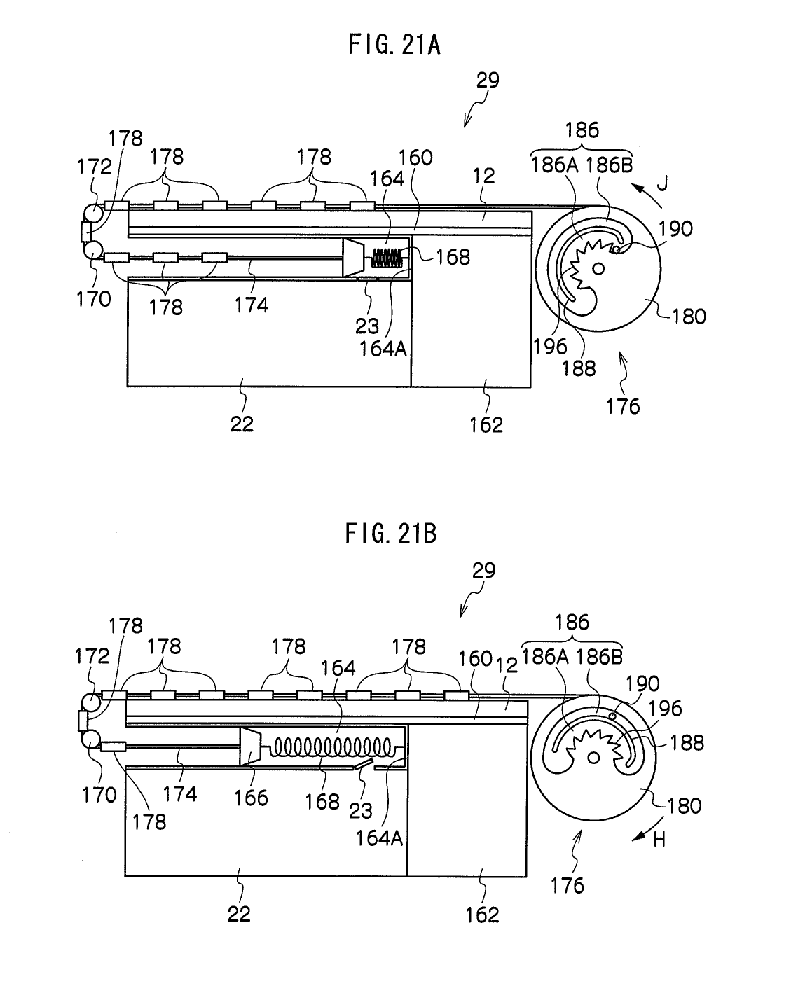

When the fuel cell 12 generates further electricity, as shown in FIG. 21A, the fuel in the second fuel chamber 160 is consumed, and, by the consumption of fuel in the second fuel chamber 160, fuel from the first fuel chamber 164 is supplied to the second fuel chamber 160.

The internal pressure of the first fuel chamber 164 is reduced by the supply of fuel from the first fuel chamber 164, and the piston 166 moves toward the bottom wall 164A by biasing force of the coil spring 168. When the piston 166 moves, the wires 174 are pulled, and the water absorbing sheets 178 move along the surface of the cathode 18, and water that has accumulated on the surface of the cathode 18 is absorbed.

The engagement of the pin 190 and the latch portion 196 is also released by the pulling of the wires 174 toward the fixed pulley 172, and the roll portion 180 rotates in an anti-clockwise direction (the direction shown by arrow J in FIG. 21A). The pin 190 passes the latch portion 196 and reaches the outer peripheral edge of the internal groove portion 186A due to the rotation of the roll portion 180 in an anti-clockwise direction.

When the pin 190 reaches the outer peripheral edges of the internal groove portion 186A, as shown in FIG. 21B, the pin 190 moves along the outer peripheral edge into the external groove portion 186B, and abuts the outside of the wall portion 188.

The pin 190 becomes un-engaged from the latch portion 196 by abutting the outside of the wall portion 188, and the rotation of the roll portion 180 in a clockwise direction becomes enabled. The roll portion 180 then rotates in a clockwise direction by biasing force of the coil spring 200.

The wires 174 are wound up on the roll portion 180 by the rotation of the roll portion 180 in a clockwise direction, the water absorbing sheets 178 move along the cathode 18 toward the wheel 176, and water that has accumulated on the surface of the cathode 18 is absorbed.

The piston 166 is further pulled by the wires 174 and moved in the direction that increases the volume of the first fuel chamber 164. When the volume of the first fuel chamber 164 increases, the internal pressure of the first fuel chamber 164 rapidly decreases, and the suction valve 23 is opened thereby, and fuel of the fuel cartridge 22 is supplied to the first fuel chamber 164. The piston 166 returns to the initial position shown in FIG. 20A by the fuel being supplied to the first fuel chamber 164, to be ready for the next wiping movement.

Running costs may hence be suppressed, since the water absorbing sheets 178 may be moved along the surface of the cathode 18 and wipe off water in this manner without using a power source such as a motor.

Furthermore, since the water absorbing sheets 178 are disposed at a predetermined intervals, the entire surface of the cathode 18 is not covered at any one time, and air may be continuously supplied, as an oxidant, to the cathode 18, and so stable electricity supply may be achieved.

It should be noted that the present invention has been explained with respect to particular exemplary embodiments, however, the present invention is not limited to these exemplary embodiments, and it is clear to a person of skill in the art that various other embodiments are possible within the scope of the present invention. For example, in the above exemplary embodiment the water absorbing sheets 178 are shaped like V's, however, instead of this they may be of a rectangular shape or the like.

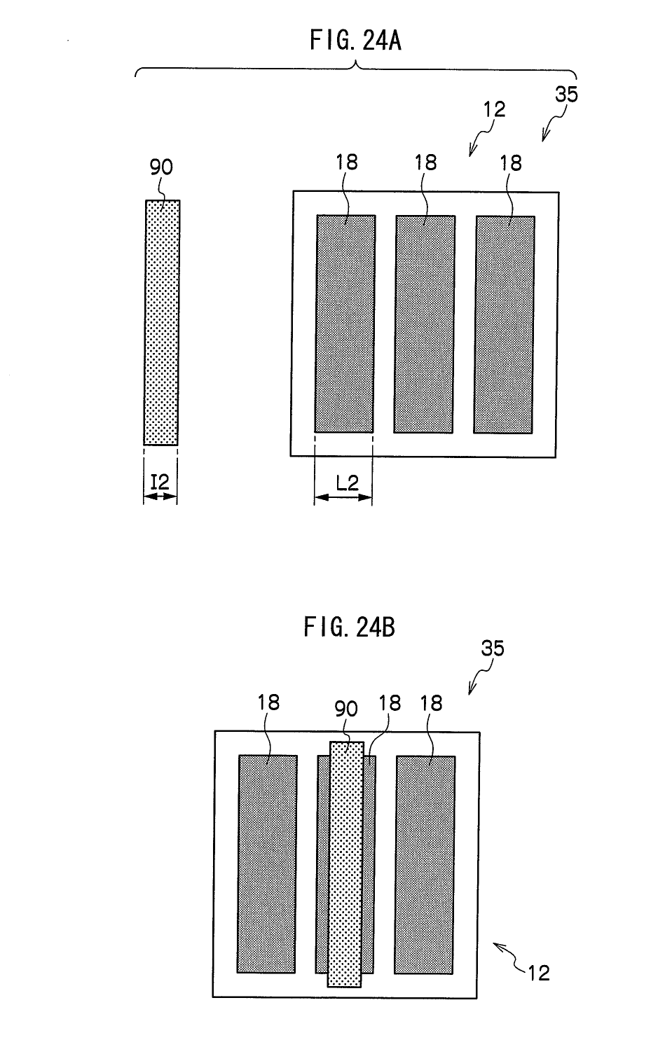

Explanation will now be given of a mobile phone 30 employing a fuel cell device 35 according to an eleventh exemplary embodiment of the present invention, with reference to FIGS. 24A and 24B.

It should be noted that similar components to those of the fourth exemplary embodiment are allocated the same reference numerals, and explanation thereof is omitted.

In the present exemplary embodiment, the cathode 18 is not integrally formed as in the fourth exemplary embodiment, but there are three divided cathodes 18 along the movement direction of the water absorbing block 90, and each cathode 18 is rectangular in shape, extending in the width direction of the water absorbing block 90, as shown in FIG. 24A.

In addition, the length of the water absorbing block 90 in the conveying direction (the dimension 12 shown in FIG. 24A) is shorter than the length of each cathode 18 (the dimension L2 shown in FIG. 24A), such that the water absorbing block 90 does not cover all of the surface of the cathode 18 at any one time, as shown in FIG. 24B.

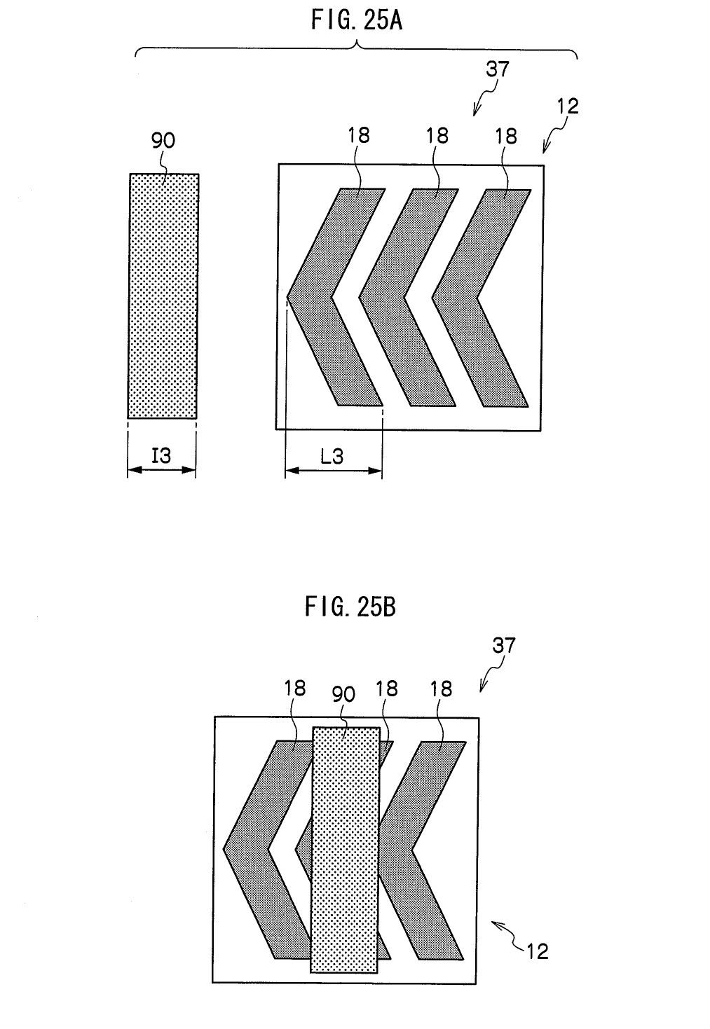

Explanation will now be given of a mobile phone 30 employing a fuel cell device 37 according to a twelfth exemplary embodiment of the present invention, with reference to FIGS. 25A and 25B.

It should be noted that similar components to those of the eleventh exemplary embodiment are allocated the same reference numerals, and explanation thereof is omitted.

In the present exemplary embodiment, the cathode 18 is not rectangular in shape as in the eleventh exemplary embodiment, but instead is V shaped, as shown in FIG. 25A.

In addition, the length of the water absorbing block 90 in the conveying direction (the dimension 13 shown in FIG. 25A) is shorter than the overall length of each V-shaped cathode 18 (the dimension L3 shown in FIG. 25A), such that the water absorbing block 90 does not cover the entire surface of the cathode 18 at any one time, as shown in FIG. 25B.

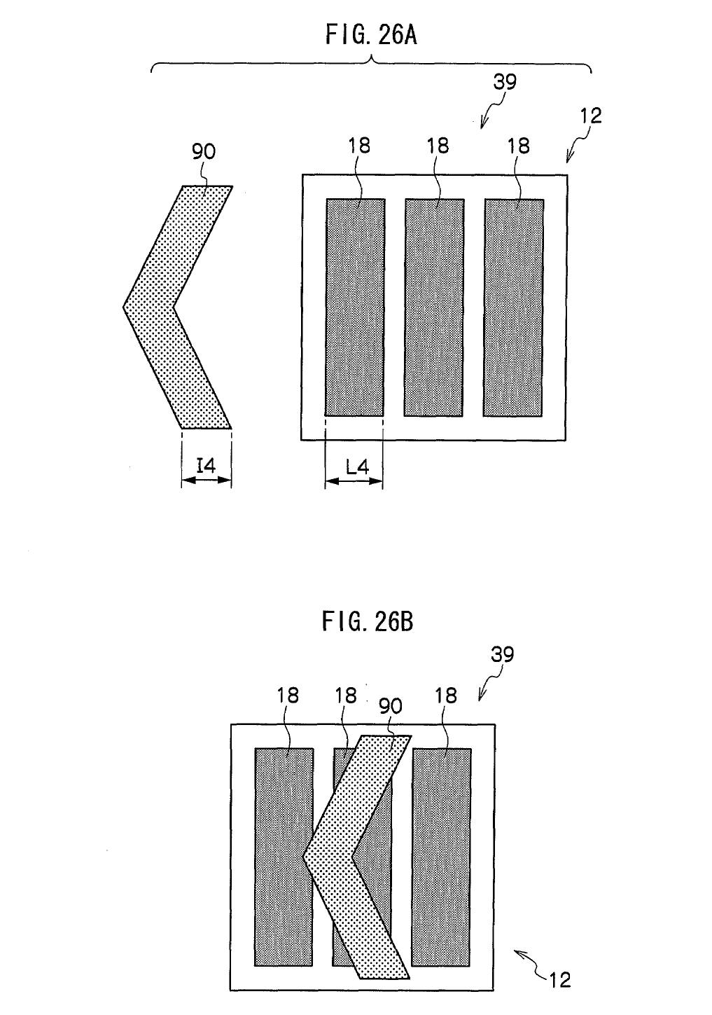

Explanation will now be given of a mobile phone 30 employing a fuel cell device 39 according to a thirteenth exemplary embodiment of the present invention, with reference to FIGS. 26A and 26B.

It should be noted that similar components to those of the eleventh exemplary embodiment are allocated the same reference numerals, and explanation thereof is omitted.

In the present exemplary embodiment, the water absorbing block 90 is different from that of the eleventh exemplary embodiment in that it is of a V shape, as shown in FIG. 26A.

In addition, the side-length of the water absorbing block 90 in the conveying direction (the dimension 14 shown in FIG. 26A) is shorter than the length of each cathode 18 (the dimension L4 shown in FIG. 26A), such that the water absorbing block 90 does not cover the entire surface of the cathode 18 at any one time, as shown in FIG. 26B.

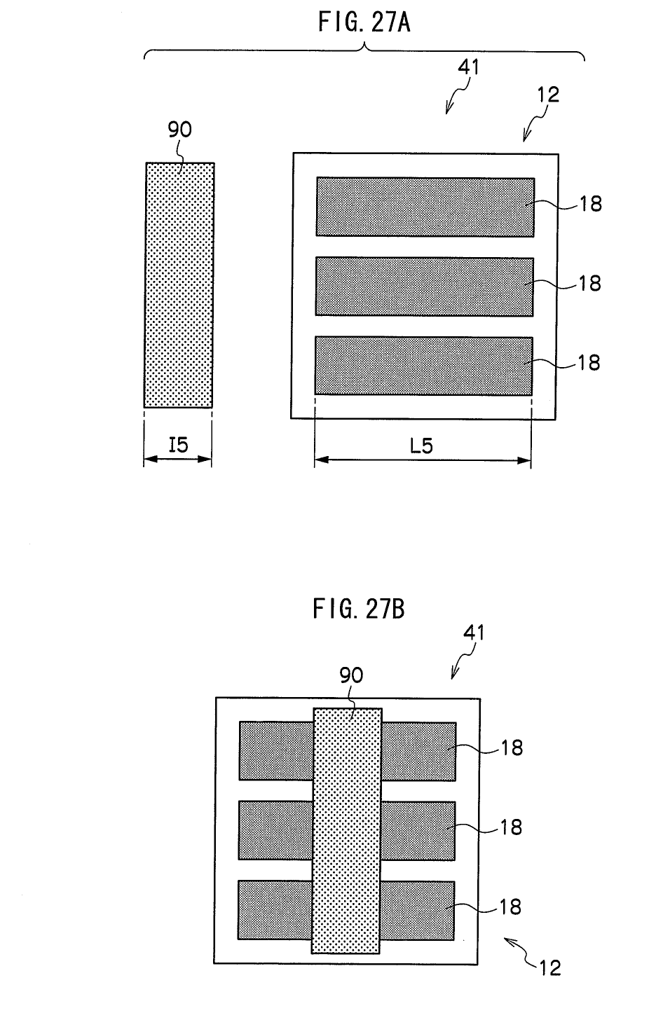

Explanation will now be given of a mobile phone 30 employing a fuel cell device 41 according to a fourteenth exemplary embodiment of the present invention, with reference to FIGS. 27A and 27B.

It should be noted that similar components to those of the eleventh exemplary embodiment are allocated the same reference numerals, and explanation thereof is omitted.

In the present exemplary embodiment, in contrast to in the eleventh exemplary embodiment, there are three divided cathodes 18 in the water absorbing block 90 width direction, as shown in FIG. 27A, such that the water absorbing block 90 does not cover the entire surface of the cathode 18 at any one time, as shown in FIG. 27B.

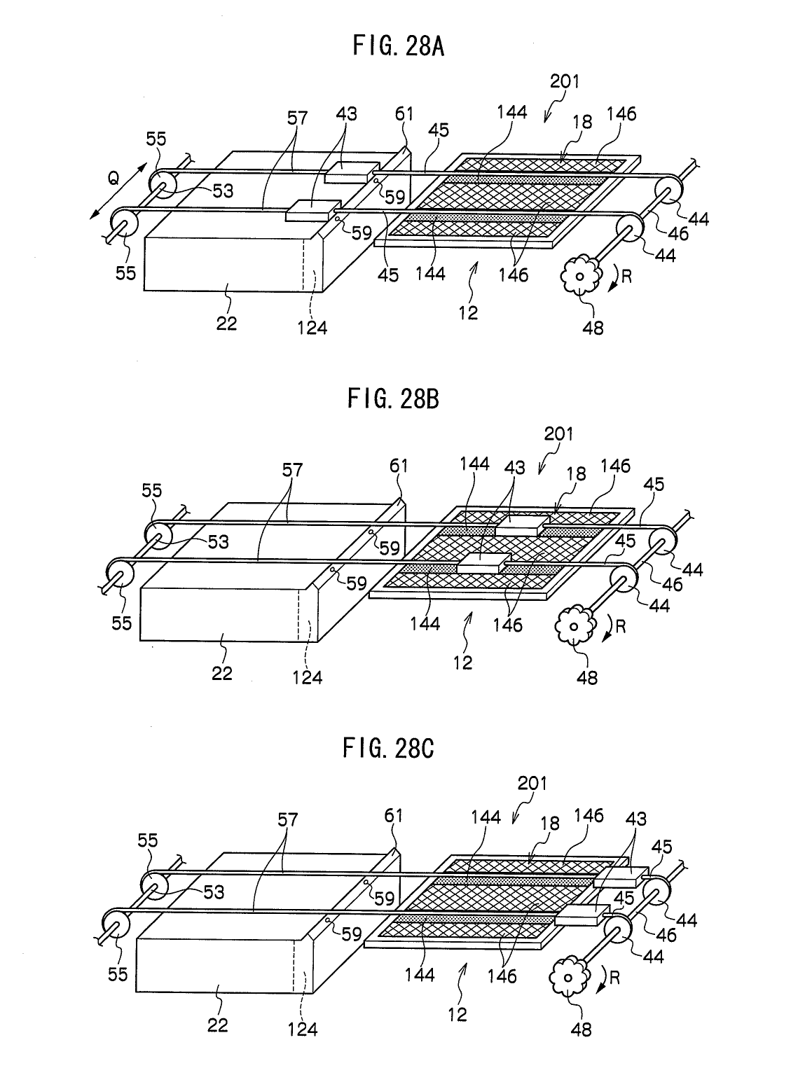

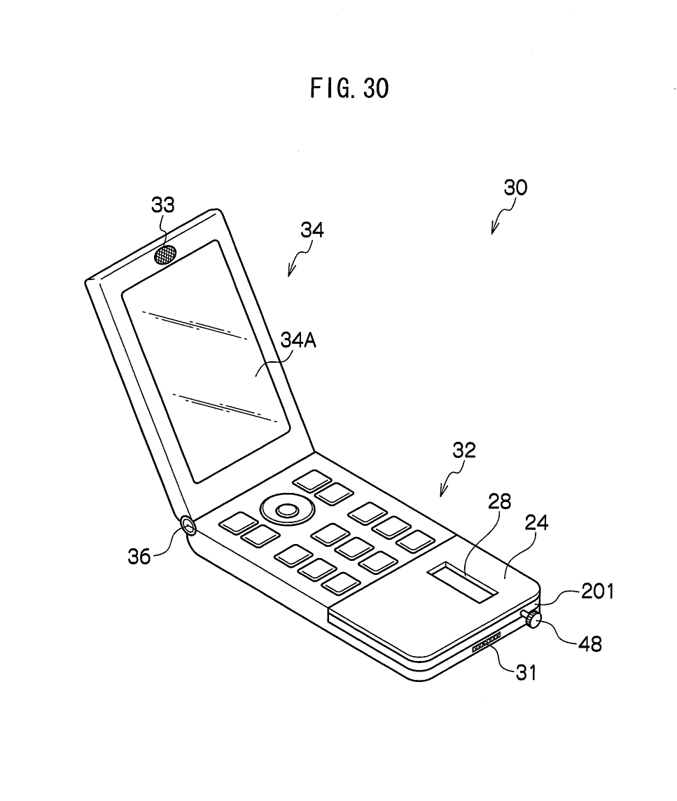

Explanation will now be given of a mobile phone 30 employing a fuel cell device 201 according to a fifteenth exemplary embodiment of the present invention, with reference to FIGS. 28A to 30.

The mobile phone 30 is provided with: a plate-shaped operation member 32 with various operation keys, such as a power switch, and with a microphone 31; a display member 34, with a display screen 34A for displaying information and the like based on information from the operation member 32, and with a speaker 33; and a hinge member 36, which is able to maintain the display member 34 in an open or closed state with respect to the operation member 32.

A fuel cell device 201, for supplying power to the mobile phone 30, is mounted at the opposite side to that of the hinge member 36 of the operation member 32. In order to protect the fuel cell device 201 there is, in addition, a thin plate-shaped protection member 24 provided so as to cover the fuel cell device 201 from the outside. There is also a rectangular opening portion 28 provided in the protection member 24, through which air (oxygen) is supplied as an oxidant to the fuel cell device 201.

Explanation will now be given of the water absorbing member and the like for removing water that has accumulated on the surface of the cathode 18.

As shown in FIG. 28A, there are two water absorbing blocks 43 provided as water absorbing members above the fuel cartridge 22 in which fuel is stored, the water absorbing blocks 43 being provided along the fuel cartridge 22 width direction (the direction shown by the arrow Q in FIG. 28A).

One end of the each of the wires 45 is attached to one edge of the water absorbing blocks 43 (the edge that faces the fuel cell 12) and the other end of each of the wires 45 extends along the surface of the cathode 18 and is fixed to respective pulleys 44 that are provided in positions that face the water absorbing blocks 43, with the fuel cell 12 disposed therebetween.

The pulleys 44 are mounted to a rotational shaft 46 that is rotationally supported by non-illustrated brackets. There is a substantially circular shaped dial 48 fixed to one end of the rotational shaft 46 so as to enable manual rotation thereof, and the dial 48 is provided so as to protrude out from the mobile phone 30.

One end of each of the wires 57 is attached to the other edge of the water absorbing blocks 43, and the other end of each of the wires 57 is fixed to pulleys 55 that are provided on the opposite side of the fuel cartridge 22 to the fuel cell 12. The pulleys 55 are mounted to a rotational shaft 53 that is rotationally supported by a non-illustrated frame member.

There is also a non-illustrated coil spring provided to the rotational shaft 53 such that the water absorbing blocks 43 are biased to be disposed above the fuel cartridge 22. The water absorbing blocks 43 are thereby biased to be above the fuel cartridge 22 in a state in which there is no external force acting.

When the wires 45 are wound up on the pulleys 44 and the water absorbing blocks 43 slide along the surface of the cathode 18, at the surface of the cathode 18 over which the water absorbing blocks 43 pass, there are two hydrophilic portions 144 provided that have been treated with a hydrophilic coating having hydrophilic properties, the hydrophilic portions 144 extending in the movement direction of the water absorbing blocks 43.

On the surface of the cathode 18 there are also three hydrophobic portions 146 provided that have been treated with a hydrophobic coating having hydrophobic properties, the hydrophobic portions 146 being provided so as to sandwich the two hydrophilic portions 144 therebetween. Thereby, water that has been generated on the surface of the cathode 18 is repelled by the hydrophobic portions 146 and accumulates in the hydrophilic portions 144.

It should be noted that in the present exemplary embodiment the solid polymer membrane 20 is 7 cm×7 cm, the cathode 18 is 6 cm×6 cm, and the width of the hydrophilic portions 144 is 2 mm, however, the width of the hydrophilic portions 144 is drawn expanded in FIGS. 28A to 28C for clarity.

There is a triangular cross-section squeeze protrusion portion 61 provided on the top face of the fuel cartridge 22, so as to be able to be sandwiched between the water absorbing blocks 43 and fuel cell 12, the squeeze protrusion portion 61 being provided adjacent to the water absorbing blocks 43 as shown in FIG. 28A. The water absorbing blocks 43 are thereby pressed by the squeeze protrusion portion 61 when the water absorbing blocks 43 are pushed-pulled by the wires 45, 50 across the squeeze protrusion portion 61, and water that has been absorbed by the water absorbing blocks 43 is squeezed out therefrom.

There are also water absorbing holes 59 provided to the surface of the squeeze protrusion portion 61, and there is also a porous member 124 provided within the fuel cartridge 22 for absorbing water that has passed into the fuel cartridge 22 from the water absorbing holes 59.

Explanation will now be given of the movement for removing water that has been generated on the surface of the cathode 18 and been accumulated in the hydrophilic portions 144.

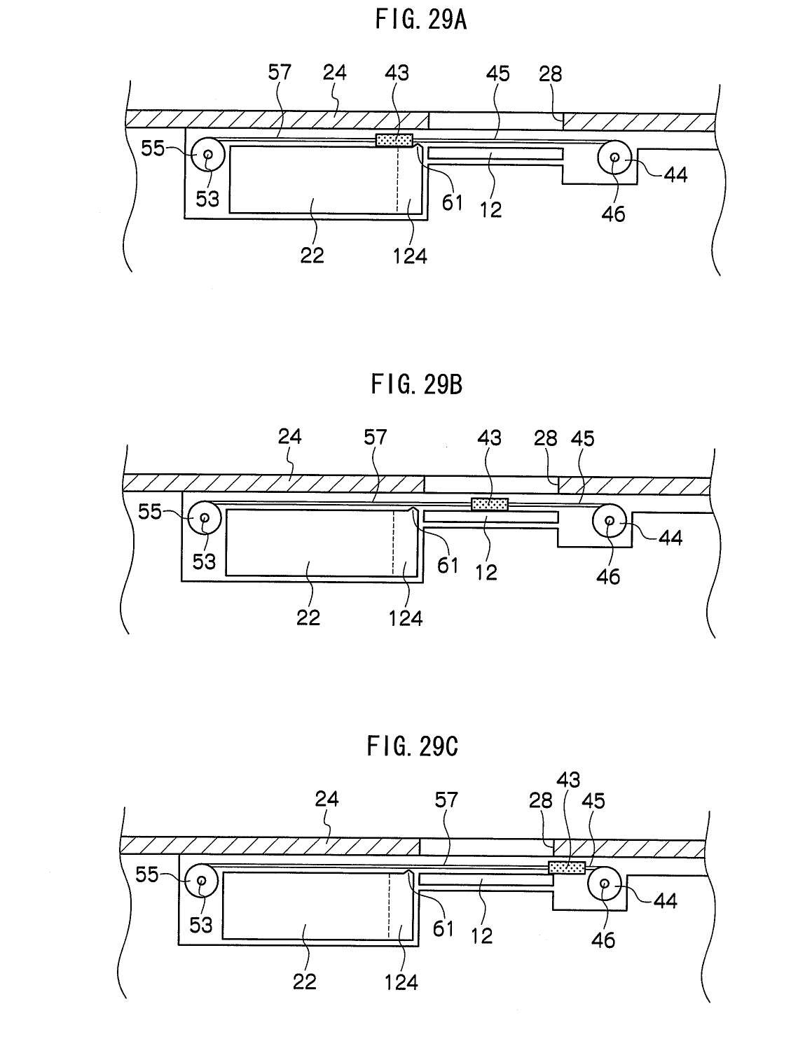

In a state in which there is no rotational force load on the dial 48, as shown in FIGS. 28B and 29B, the water absorbing blocks 43 are disposed above the fuel cartridge 22 by biasing force of the coil spring.

When the dial 48 is rotated in the direction of arrow R about the rotational shaft 46, as shown in FIGS. 28B and 29B, the pulleys 44 also rotate therewith, and the pulleys 44 wind up the wires 45.

The water absorbing blocks 43, which are each attached to one end of each of the wires 45, slide along the hydrophilic portions 144 of the surface of the cathode 18 due to the pulleys 44 winding up the wires 45.

Rotation of the dial 48 in the direction of arrow R is prevented by a non-illustrated stopper when the water absorbing blocks 43 pass the hydrophilic portions 144, as shown in FIGS. 28C and 29C.

When the load is released from the dial 48, the water absorbing blocks 43 is biased by biasing force of the coil spring provided to the rotational shaft 53, and returned to the initial position above the fuel cartridge 22, as shown in FIG. 28A.

When the water absorbing blocks 43 are returned to the initial position, the surface of the water absorbing blocks 43 are pressed by the squeeze protrusion portion 61, and water that had been absorbed therein comes out from the surface of the water absorbing blocks 43. The water that comes out therefrom passes through the water absorbing holes 59 that are provided to the squeeze protrusion portion 61 and is collected by the porous member 124 that is provided within the fuel cartridge 22.

Water that has been generated on the surface of the cathode 18 and accumulated in the hydrophilic portions 144 may be removed by the water absorbing blocks 43 sliding along the hydrophilic portions 144 of the cathode 18 in this manner.

Furthermore, since the sliding water absorbing blocks 43 do not cover the entire surface of the cathode 18, they is no impediment to the supply of air to the cathode 18.

Since the porous member 124 collects the water that has been absorbed by the water absorbing blocks 43, the water absorbing blocks 43 may sufficiently remove the water that has been accumulated in the hydrophilic portions 144, even when operated the next time. It should be noted that a porous material with hydrophilic properties may be used for the water absorbing blocks 43. Porous bodies may be used that are made from, for example, felt, sponge, resin particle sintered bodies, resin fiber sintered bodies, natural fibers, resin fiber bundles and the like. It is furthermore preferable that a substance such as polyester or rayon is used for the water absorbing blocks 43. Configuration may also be made such that the water absorbing blocks 43 do not make contact with the surface of the cathode 18, but rather contact with the liquid surface of droplets of water that are adhered to the surface, and absorb the water thereby.

It should be noted that explanation has been given of the present invention with reference to particular exemplary embodiments, however the present invention is not limited to these exemplary embodiments, and it will be clear to a person of skill in the art that various other embodiments are possible within the scope of the present invention. For example, in the above exemplary embodiment the water absorbing blocks 43 are slid along the hydrophilic portions 144 by rotating the dial 48, but driving force, such as from a motor, may be used instead for sliding the water absorbing blocks 43.

Explanation will now be given of a mobile phone 30 employing a fuel cell device 203 according to a sixteenth exemplary embodiment of the present invention, with reference to FIGS. 31A to 32B, and FIG. 11.

It should be noted that similar components to those of the fifteenth exemplary embodiment are allocated the same reference numerals, and explanation thereof is omitted.

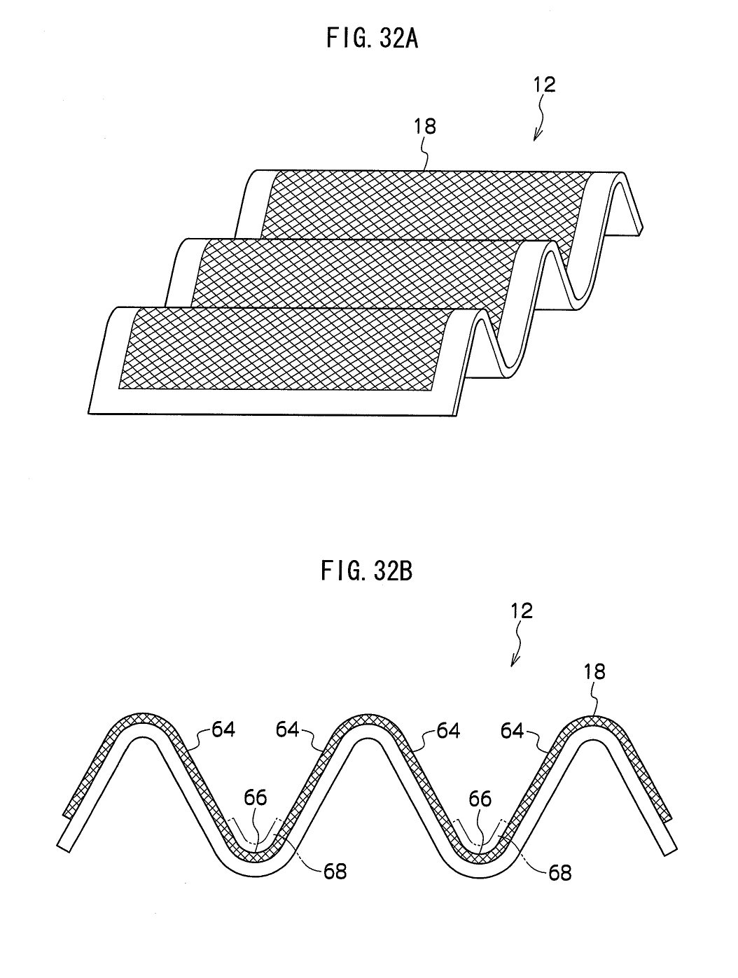

In the present exemplary embodiment, the fuel cell 12 is not formed in a flat plate shape as in the fifteenth exemplary embodiment, but instead, as shown in FIGS. 32A, 32B, the fuel cell 12 is formed in a wave shape, when viewed from the conveying direction of the absorbing member. There are also no hydrophilic portions 144 and hydrophobic portions 146 provided to the surface of the cathode 18. Thereby the configuration is such that water that is generated on the surface of the cathode 18 flows down inclined faces 64 of the wave shape under gravity, and accumulates in bottom portions 66 (water accumulating portions).

It should be noted that in the present exemplary embodiment the periodicity between the peaks of the wave form is 1.4 cm, and the amplitude of the wave form is 0.7 cm.

The shape of water absorbing blocks 68 are a curved shape around the bottom portions 66, such that the water absorbing blocks 68 are able to efficiently absorb the water that has been collected in the bottom portions 66. It should be noted that there are bevels (omitted in the figures) formed to the faces of the water absorbing blocks 68 that face toward the fuel cell 12, such that the water absorbing blocks 68 slide along the bottom portions 66 without catching on the end faces of the fuel cell 12. FIG. 32B is also drawn with the anode 16 omitted therefrom.

There is also a motor 100 provided to one end of a rotational shaft 46. There is also a timing control unit 106 provided to the fuel cell device 203, for controlling the rotation of the motor 100.

Explanation will now be given of the movement of the water absorbing blocks 68 for removing water that has accumulated in the bottom portions 66 of the cathode 18.

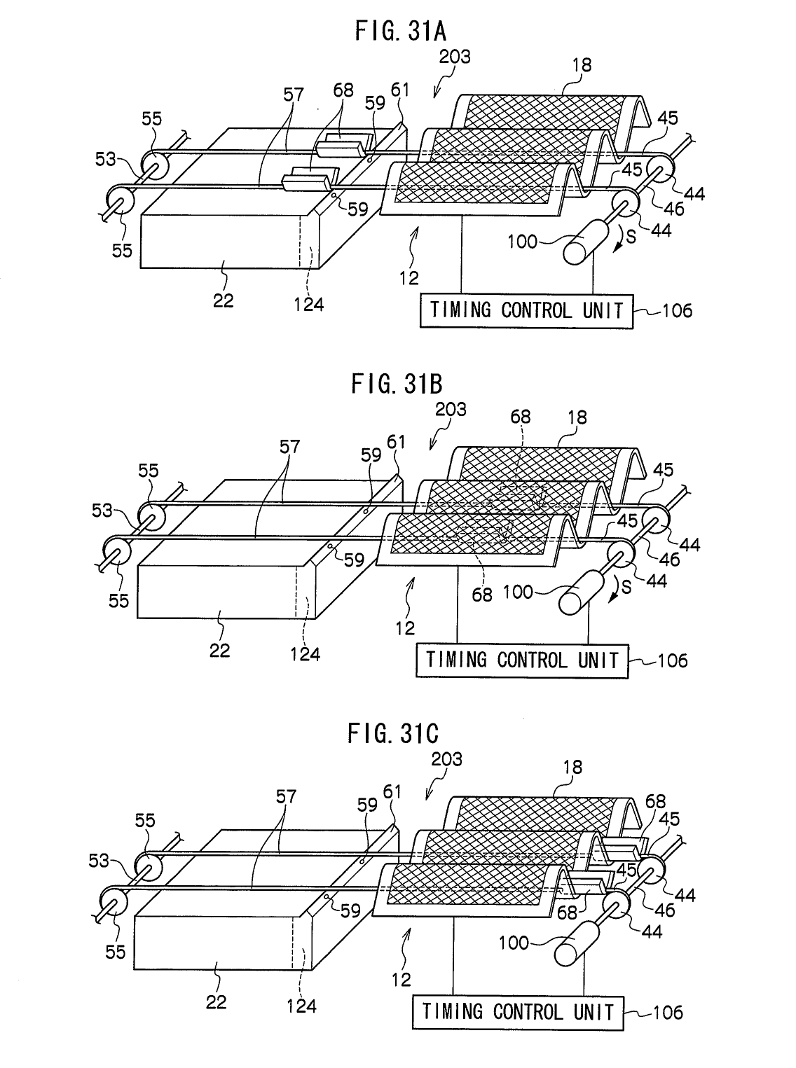

When there is no rotational force load to the motor 100, as shown in FIG. 31A, the water absorbing blocks 68 are disposed above the fuel cartridge 22 by biasing force from a coil spring.

When the timing control unit 106 rotates the motor 100 in the direction of arrow S, as shown in FIG. 31B, and pulleys 44 wind up wires 45, the water absorbing blocks 68 slide along the bottom portions 66 of the cathode 18, and water that has accumulated in the bottom portions 66 is removed.

When the water absorbing blocks 68 have slid along the bottom portions 66 and passed the cathode 18, as shown in FIG. 31C, the timing control unit 106 releases the rotational load of the motor 100 and stops the water absorbing blocks 68.

When the load of the motor 100 is released, the pulleys 55 wind up the wires 57 by biasing force from the coil spring that is provided to the rotational shaft 53, and the water absorbing blocks 68 are returned to the initial position, as shown in FIG. 31A. It should be noted that the movement duration, during which the water absorbing blocks 68 slide and remove water from the bottom portions 66 of the cathode 18, is preferably 1 second or less, in consideration of the supply of air to the cathode 18.

With regard to the timing with which the timing control unit 106 rotates the motor 100 and slides the water absorbing blocks 68 along the bottom portions 66 of the cathode 18, the timing is similar to that explained above, based on FIG. 11.

In the sixteenth exemplary embodiment, the water that is generated on the surface of the cathode 18 accumulates under gravity at the bottom portions 66, and such water at the bottom portions 66 is absorbed by sliding the absorbing blocks 68 along the bottom portions 66. Water that has been generated on the surface of the cathode 18 may thereby be removed from the surface of the cathode 18.

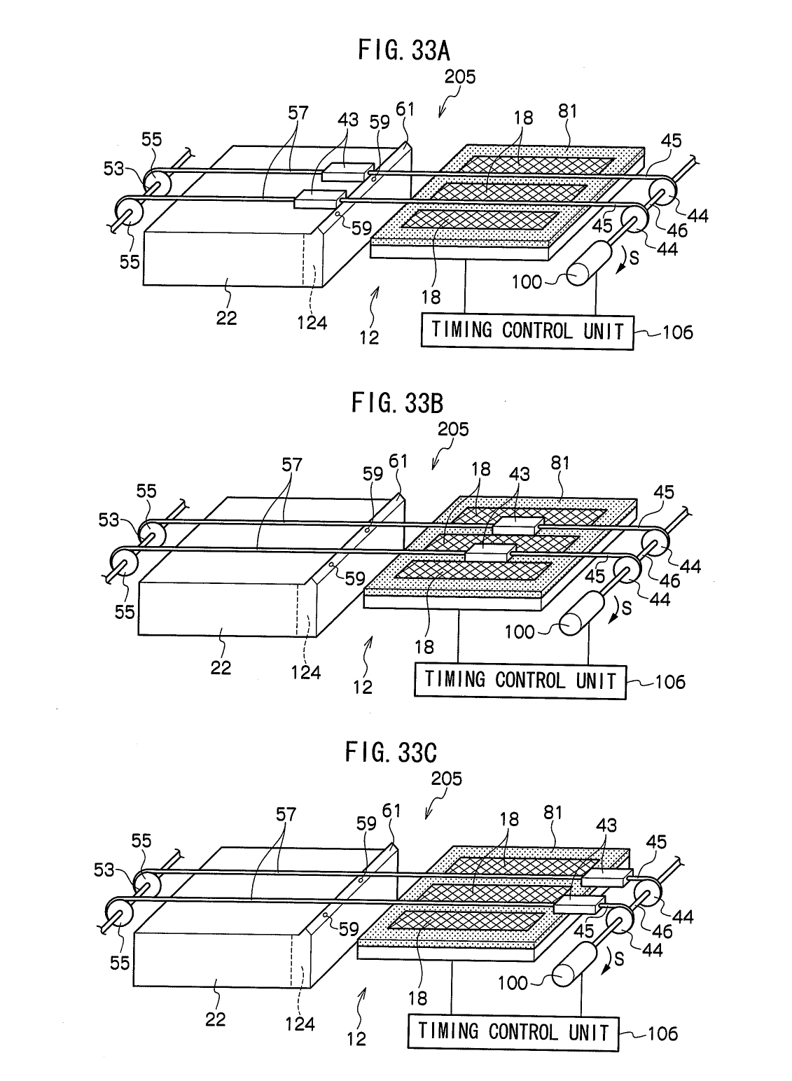

Explanation will now be given of a mobile phone 30 employing a fuel cell device 205 according to a seventeenth exemplary embodiment of the present invention, with reference to FIGS. 33A to 33C.

It should be noted that similar components to those of the sixteenth exemplary embodiment are allocated the same reference numerals, and explanation thereof is omitted.

In the present exemplary embodiment, the fuel cell 12 is not formed in a wave shape as in the sixteenth exemplary embodiment, but instead the fuel cell 12 is formed in a flat plate shape, as shown in FIG. 33A, and there are three divided cathodes 18 in the direction orthogonal to the conveying direction of the water absorbing blocks 43.

Furthermore, a soak member 81 which is provided so as to abut edge portions of the three divided cathodes 18 and surround the cathodes 18, and which utilizes capillary action to take up water that has been generated on the surface of the cathodes 18, is provided so as not to cover the surface of the cathode 18.

The water absorbing blocks 43 also slides along the soak member 81 that sandwiched between the cathodes 18, and the size of the water absorbing blocks 43 is determined so as not to cover the cathode 18 when sliding.

Thereby, water that has been generated on the surface of the cathodes 18 is taken up and accumulated by the soak member 81 from edge portions of the cathode 18 utilizing capillary action, and the water that has been taken up by the soak member 81 is absorbed by the sliding water absorbing blocks 43.

Explanation will now be given of the movement of the water absorbing blocks 43 for removing the water that has been collected by the soak member 81.

In a state in which there is no rotational force load to the motor 100, as shown in FIG. 33A, the water absorbing blocks 43 are disposed above the fuel cartridge 22 by biasing force of a coil spring.

The soak member 81, which is provided so as to abut edge portions of the three divided cathodes 18 and surround the cathodes 18, takes up and accumulates the water that has been generated on the surface of the cathodes 18 utilizing capillary action.

When the timing control unit 106 rotates the motor 100 in the direction of arrow S and the pulleys 44 wind up the wires 45, as shown in FIG. 33B, the water absorbing blocks 43 are slid along the soak member 81 that is sandwiched between the cathodes 18, and absorb and remove water that has been accumulated by the soak member 81.

When the water absorbing blocks 43 passes the soak member 81 that is sandwiched between the cathodes 18, as shown in FIG. 33C, the timing control unit 106 releases the load of the motor 100, and stops the water absorbing blocks 43.

When the load of the motor 100 is released, the pulleys 55 wind up the wires 57 with biasing force of the coil spring provided to the rotational shaft 53, and the water absorbing blocks 43 are returned to the initial position, as shown in FIG. 33A.

The water that has been generated on the surface of the cathode 18 is taken up and accumulated in this manner by the soak member 81 utilizing capillary action, and the water that has been collected by the soak member 81 is absorbed by the water absorbing blocks 43 sliding along the soak member 81. Water that has been generated on the surface of the cathode 18 may thereby be removed.

Furthermore, since the sliding water absorbing blocks 43 do not cover the surface of the cathode 18, there is no impediment to the supply of air to the cathode 18.

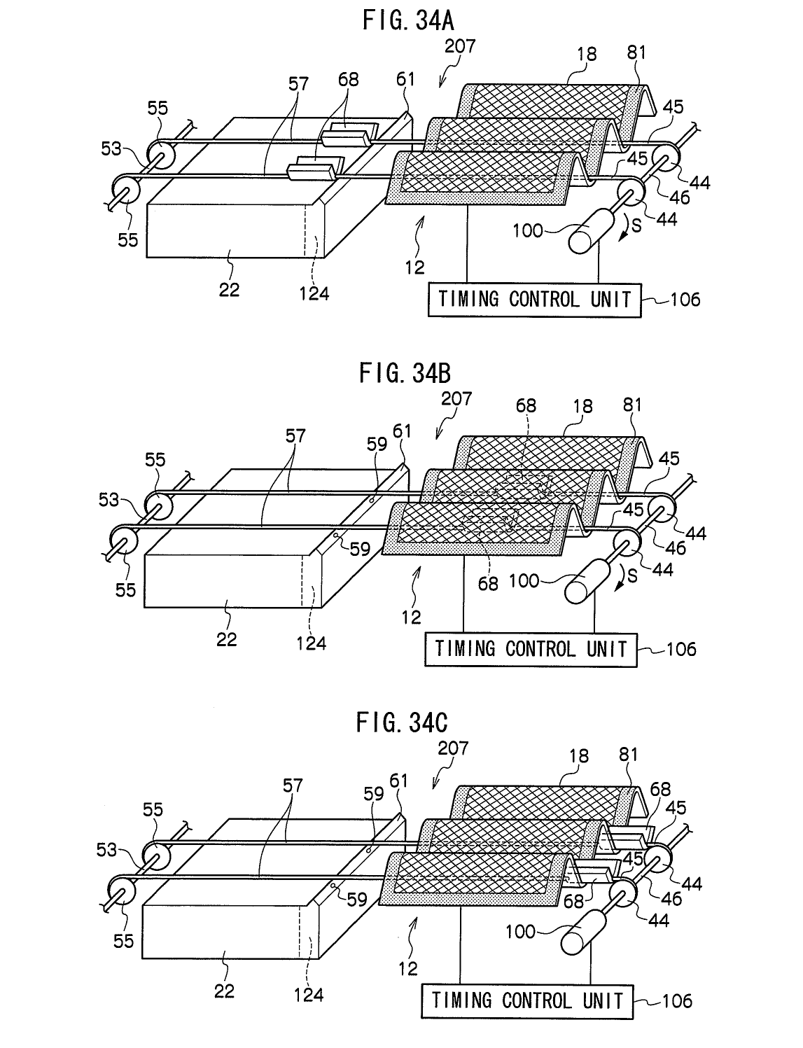

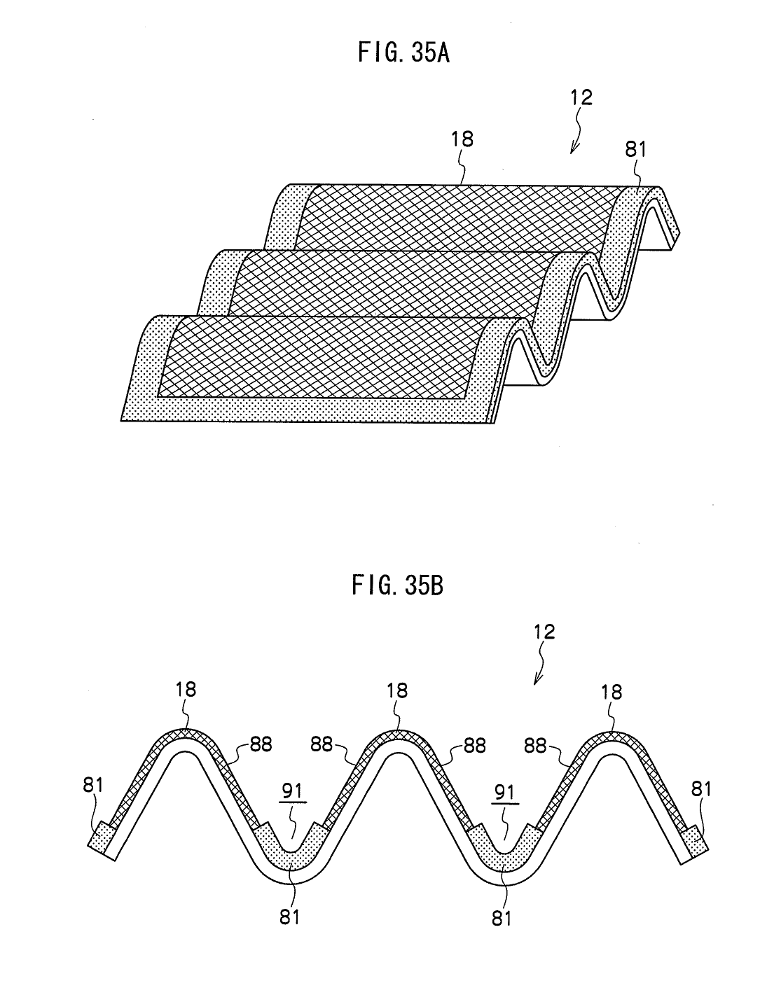

Explanation will now be given of a mobile phone 30 employing a fuel cell device 207 according to an eighteenth exemplary embodiment of the present invention, with reference to FIGS. 34A to 35B.

It should be noted that similar components to those of the seventeenth exemplary embodiment are allocated the same reference numerals, and explanation thereof is omitted.

In the present exemplary embodiment, the fuel cell 12 is not formed in a flat plate shape as in the seventeenth exemplary embodiment, but instead the fuel cell 12 is formed so as to be in a wave shape when viewed from the conveying direction of the water absorbing member, as shown in FIG. 35A. In addition, the soak member 81 that is sandwiched between the cathodes 18 is disposed at bottom portions 91 of the wave shape.

Thereby, configuration is such that water that is generated on the surface of the cathode 18, flows down inclined faces 88 of the wave form under gravity, and is taken up and accumulated by the soak member 81.

It should be noted that in the present exemplary embodiment the periodicity between peaks in the wave shape is 1.4 cm, and the amplitude of the wave shape is 0.7 cm.

The shape of the water absorbing blocks 68 is formed in a curved shape around the bottom portions 91, such that water that has been accumulated in the soak member 81 may be efficiently absorbed. The size of the water absorbing blocks 68 is determined such that the water absorbing blocks 68 do not cover the cathode 18 during sliding. It should be noted that there are bevels (omitted in the figures) formed to the water absorbing blocks 68 on faces thereof that face toward the fuel cell 12, such that the water absorbing blocks 68 slide along the bottom portions 91 and do not catch on the end faces of the fuel cell 12. The anode 16 is omitted from FIG. 35B.

Explanation will now be given of the movement of the water absorbing blocks 68 for removing water that has been accumulated in the soak member 81.

In a state in which there is no rotational force load to the motor 100, the water absorbing blocks 68 are disposed above the fuel cartridge 22 by biasing force of a coil spring, as shown in FIG. 34A.

When the timing control unit 106 rotates the motor 100 in the direction of arrow S and the pulleys 44 wind up the wires 45, as shown in FIG. 34B, the water absorbing blocks 68 slide along the bottom portions 91 and absorb and remove water that has been accumulated in the soak member 81.

When the water absorbing blocks 68 slide along the bottom portions 91 and pass the soak member 81 that is sandwiched between the cathodes 18, as shown in FIG. 34C, the timing control unit 106 releases the load of the motor 100 and stops the water absorbing blocks 68.

When the load of the motor 100 is released, the pulleys 55 wind up the wires 57 with biasing force from a coil spring that is provided to the rotational shaft 53, and the water absorbing blocks 68 are returned to the initial position, as shown in FIG. 34A.

The soak member 81 accumulates water that has been generated on the surface of the cathode 18 utilizing gravity and capillary action, and furthermore, the water absorbing blocks 68 absorbs the water that has been accumulated in the soak member 81 by sliding along the soak member 81. The water that has been generated on the surface of the cathode 18 may thereby be removed.

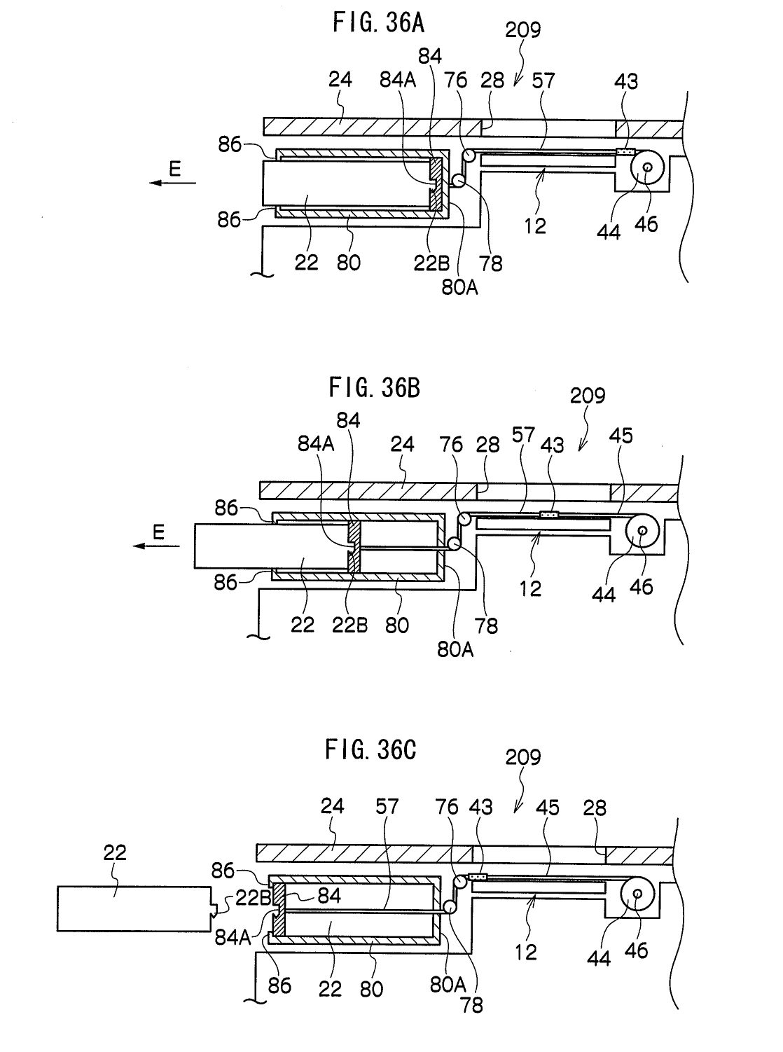

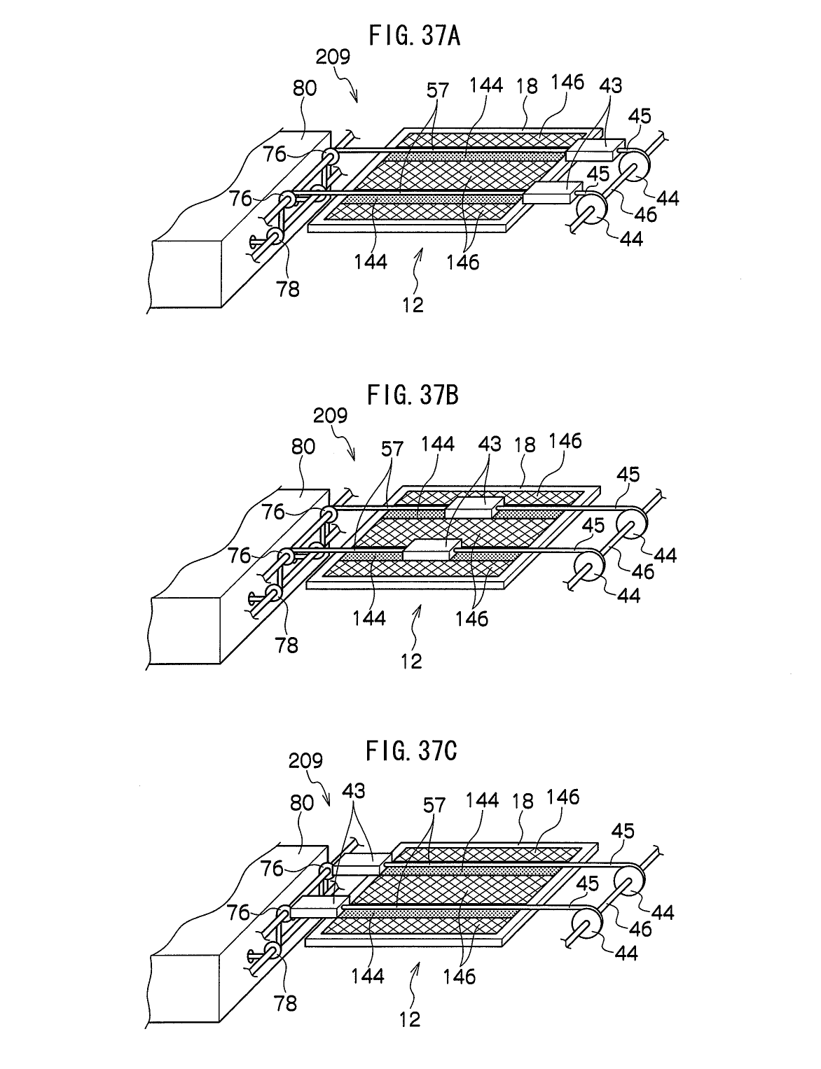

Explanation will now be given of a mobile phone 30 employing a fuel cell device 209 according to a nineteenth exemplary embodiment of the present invention, with reference to FIGS. 36A to 37C.

It should be noted that similar components to those of the fifteenth exemplary embodiment are allocated the same reference numerals, and explanation thereof is omitted.

In the present exemplary embodiment, the water absorbing blocks 43 as absorbing members are not disposed above the fuel cartridge 22 as in the fifteenth exemplary embodiment, but instead are disposed above pulleys 44 that are disposed in positions that face the fuel cartridge 22, with the fuel cell 12 positioned therebetween, as shown in FIG. 37A.

There is a non-illustrated coil spring provided to the rotational shaft 46 that rotationally supports the pulleys 44, the coil spring biasing the water absorbing blocks 43 to over the pulleys 44. The water absorbing blocks 43 are thereby biased to above the pulleys 44 in a state in which there is no external force acting.

Wires 57 that are attached to end portions of the water absorbing blocks 43 extend along the surface of the cathode 18, and are wound around fixed pulleys 76, which are disposed between the fuel cell 12 and the fuel cartridge 22, and extend downwards. The end portions of the wires 57 that extend downwards are wound around fixed pulleys 78 that are disposed below the fixed pulleys 76, and pass through the back wall 80A of the fuel cartridge case 80 that accommodates the fuel cartridge 22, and are inserted into the fuel cartridge case 80.

There is a push-pull plate 84 provided at the inside of the back wall 80A of the fuel cartridge case 80, as shown in FIG. 36A, and the end portions of the wires 57 are fixed thereto. There is an indented engaging recess portion 84A formed to the fuel cartridge 22 side of the push-pull plate 84, so that an engaging protrusion portion 22B that is provided to the fuel cartridge 22 engages therewith. Thereby, when the fuel cartridge 22 is pulled out in the direction shown by arrow E in FIG. 36A, the push-pull plate 84 also slides with the fuel cartridge 22 in the direction shown by arrow E since the engaging protrusion portion 22B and the engaging recess portion 84A are engaged.

There is also a pull-catch portion 86, protruding out to the inside, provided to an edge portion of the fuel cartridge case 80 that is open for replacing the fuel cartridge 22. When replacing the fuel cartridge 22, as shown in FIG. 36C, the push-pull plate 84 that slides with the fuel cartridge 22 abuts the pull-catch portion 86, and the engagement of the engaging protrusion portion 22B with the engaging recess portion 84A is released, such that the push-pull plate 84 remains within the fuel cartridge case 80.

Explanation will now be given of the movement of the water absorbing blocks 43 for removing water that is generated on the surface of the cathode 18 and accumulated in hydrophilic portions 144.

In the state in which the fuel cartridge 22 is accommodated in the fuel cartridge case 80, as shown in FIGS. 36A and 37A, the water absorbing blocks 43 are disposed above the pulleys 44 by biasing force of a coil spring. A user then pulls out the fuel cartridge 22 in the direction of arrow E when changing the fuel cartridge 22.

When the fuel cartridge 22 is pulled out in the direction of arrow E, as shown in FIGS. 36B and 37B, the push-pull plate 84 slides with the fuel cartridge 22 in the direction of arrow E, since the engaging protrusion portion 22B of the fuel cartridge 22 is engaged with the engaging recess portion 84A of the push-pull plate 84.

The wires 57 are pulled by the sliding of the push-pull plate 84, and the water absorbing blocks 43 that are attached to the wires 57 slide along the hydrophilic portions 144.

When the water absorbing blocks 43 pass the hydrophilic portions 144, as shown in FIGS. 36C and 37C, the push-pull plate 84 abuts with the pull-catch portion 86 and the engagement of the engaging protrusion portion 22B with the engaging recess portion 84A is released, such that the push-pull plate 84 is left remaining within the fuel cartridge case 80. When the push-pull plate 84 is left behind, the push-pull plate 84 slides toward the back wall 80A with biasing force from the coil spring provided to the rotational shaft 46, and the water absorbing blocks 43 returns to the initial position above the pulleys 44, as shown in FIG. 37A.

Thereby, by simply replacing the fuel cartridge 22, the water absorbing blocks 43 may be slid along the hydrophilic portions 144, and the water that has been generated on the surface of the cathode 18 and that has accumulated in the hydrophilic portions 144 may be removed.

It should be noted that configuration is made such that the engaging protrusion portion 22B engages with the engaging recess portion 84A by pushing the new fuel cartridge 22 into the fuel cartridge case 80.

It should be noted that while detailed explanation has been made of particular exemplary embodiments of the present invention, the present invention is not limited to these exemplary embodiments, and it will be clear to a person of skill in the art that various other embodiments are possible within the scope of the present invention. For example, in the above exemplary embodiment, while there is no particular reference thereto, a mesh shaped protection member or the like that allows water to come out to the surface thereof may be provided on the surface of the cathode 18, and abutment of the absorbing member with the surface of the cathode 18 may be avoided. In such a case, the surface of the cathode 18 may be protected. It should be noted that a polyamide or the like that has been treated with Teflon (registered trade mark) or gold plating may be used for the substance of such a mesh shaped protection member.

Furthermore, in the above exemplary embodiments the mobile phone is used as an example for explaining the fuel cell device of the present invention, however there is no limitation to the mobile phone, and the fuel cell device of the present invention may be used in all electrical devices, such as portable computers, portable game consoles, digital cameras, movie players and the like.

The present invention removes water that has been generated on the surface of a cathode.

A first aspect of the present invention provides a fuel cell device including: a fuel cell including an anode as a fuel electrode, a cathode as an oxidant electrode, and a solid polymer membrane that is disposed between the anode and the cathode; a water absorbing member that absorbs water; and a moving unit that moves the water absorbing member along a surface of the cathode.

According to the above-described aspect, hydrogen is supplied as fuel to the anode, and oxygen is supplied as an oxidant to the cathode, and the fuel cell generates electricity by an electrochemical reaction occurring through the solid polymer membrane.

When this reaction occurs, there is water generated at the surface of the cathode by the electrochemical reaction between the fuel and oxygen.

However, since the moving unit moves the water absorbing member along the surface of the cathode, the water that has been generated on the surface of the cathode may be removed.

In the above-described aspect, the fuel cell may be provided to an electrical device that has an opening and closing portion; and the moving unit may include an opening and closing movement coupling member that has one end thereof fixed to the body of the electrical device and has the other end thereof attached to the opening and closing portion so as to be able to slide, and that converts opening and closing movement of the opening and closing portion into conveying movement of the water absorbing member.

According to the above-described aspect, the fuel cell is provided to an electrical device with an opening and closing portion.

Furthermore, the opening and closing movement coupling member has one end thereof fixed to the body of the electrical device and has the other end thereof attached to the opening and closing portion so as to be able to slide, and converts opening and closing movement of the opening and closing portion into conveying movement of the water absorbing member. Thereby, by opening and closing the opening and closing portion of the electrical device, the opening and closing movement coupling member converts the opening and closing movement of the opening and closing portion into the conveying movement of the water absorbing member, and moves the water absorbing member along the surface of the cathode.

The water that has been generated on the surface of the cathode may thereby be removed.

In the above-described aspect, the moving unit may include: a guide unit that guides the water absorbing member along the surface of the cathode; and a manual operation member that manually moves the water absorbing member along the guide unit.

According to the above-described aspect, the water absorbing member, guided by the guide unit, is moved manually along the surface of the cathode using the manual operation member. Water that has been generated on the surface of the cathode may thereby be appropriately removed.

In the above-described aspect, a fuel cartridge that supplies fuel to the anode and a accommodating portion that accommodates the fuel cartridge may be further included. Also, the moving unit may include: a sliding member that is disposed at the accommodating portion so as to be able to move and that is connected to the water absorbing member; and a movement converting unit that converts detaching and attaching movement of the fuel cartridge, from and to the accommodating portion, into conveying movement of the sliding member.

According to the above-described aspect, there is a fuel cartridge that supplies fuel to the anode and the fuel cartridge is accommodated in the accommodating portion.

A sliding member, which is connected to the water absorbing member, is also disposed at the accommodating portion so as to be able to move, and, furthermore, a movement converting unit converts detaching and attaching movement of the fuel cartridge, from and to the accommodating portion, into sliding movement of the sliding member.

Thereby, when the fuel cartridge is detached and attached to the accommodating portion, the movement converting unit converts the detaching and attaching movement into sliding movement of the sliding member, and the water absorbing member that is connected to the sliding member is moved thereby along the surface of the cathode by the movement of the sliding member.

Water that has been generated on the surface of the cathode may be removed by detaching and attaching the fuel cartridge in this manner.

In the above-described aspect, the water absorbing member may be a water absorbing block, and the moving unit may slide the water absorbing block along the surface of the cathode.

According to the above-described aspect, water that has been generated on the surface of the cathode may be removed by the moving unit sliding the water absorbing block along the surface of the cathode.

In the above-described aspect, the water absorbing member may be a water absorbing sheet that is wound up on a shaft, and the moving unit may pull out along the surface of the cathode, and take up, the water absorbing sheet.

According to the above-described aspect, water that has been generated on the surface of the cathode may be removed by the moving unit pulling out along the surface of the cathode, and taking up, the water absorbing sheet that is wound up on the shaft.

In the above-described aspect, the water absorbing member may be a water absorbing sheet strip that is folded up and accommodated, and the moving unit may open up along the surface of the cathode, and accommodates, the water absorbing sheet strip.

According to the above-described aspect, the water that has been generated on the surface of the cathode may be removed by the moving unit opening up along the surface of the cathode, and accommodating, the water absorbing sheet strip that is folded up and accommodated.

In the above-described aspect, the water absorbing member may be a water absorbing roll, and the moving unit may roll the water absorbing roll along the surface of the cathode.

According to the above-described aspect, the water that has been generated on the surface of the cathode may be removed by the moving unit rolling the water absorbing roll along the surface of the cathode.

In the above-described aspect, a timing control unit may be included that actuates the moving unit for every predetermined electricity generation duration.

According to the above-described aspect, the water on the surface of the cathode may be periodically wiped off, by the timing control unit actuating the moving unit for every predetermined electricity generation duration.

In the above-described aspect, a timing control unit may be included that actuates the moving unit for every predetermined electricity generation amount.

According to the above-described aspect, the timing control unit actuates the moving unit for every predetermined electricity generation amount, and the water that has been generated may be effectively wiped off according to the amount of electricity generation.

In the above-described aspect, a timing control unit may be included that actuates the moving unit when a voltage of the fuel cell has become a predetermined voltage or below.

According to the above-described aspect, since the timing control unit actuates the moving unit when the voltage of the fuel cell has become a predetermined voltage or below, a low number of actuations are sufficient.

In the above-described aspect, a timing control unit may be included that actuates the moving unit when a change in voltage of the fuel cell has exceeded a predetermined rate.

According to the above-described aspect, since the timing control unit actuates the moving unit when the change in voltage of the fuel cell has exceeded a predetermined rate, a low number of actuations are sufficient.

In the above-described aspect, a timing control unit may be included that actuates the moving unit when current and voltage characteristics of the fuel cell have ceased to satisfy predetermined characteristics.

According to the above-described aspect, since the timing control unit actuates the moving unit when the current and voltage characteristics of the fuel cell have ceased to satisfy predetermined characteristics, a low number of actuations are sufficient.

In the above-described aspect, a water absorbing area of the water absorbing member may be less than a surface area of the cathode.

According to the above-described aspect, since the water absorbing area of the water absorbing member is less than the surface area of the cathode, the water absorbing member moving along the surface of the cathode does not cover the entire surface of the cathode at any one time. The cathode is thereby able to always take in oxygen without impediment from the water absorbing member, and the fuel cell may generate electricity in a stable state.

In the above-described aspect, the surface of the cathode may be provided with a protection member that allows water to come out of a surface thereof.

According to the above-described aspect, a protection member is provided on the surface of the cathode, the protection member allowing water to come out of the surface thereof. The water absorbing member contacts the protection member and thereby does not scratch the surface of the cathode when absorbing water.

In the above-described aspect, a squeeze unit may be included that squeezes out water that has been absorbed by the water absorbing member, and a collection unit may be included that collects water that has been squeezed out by the squeeze unit.

According to the above-described aspect, the squeeze unit squeezes out water that has been absorbed by the water absorbing member, and the collection unit collects water that has been squeezed out by the squeeze unit.

The water absorbing member is thereby always able to sufficiently absorb water on the surface of the cathode.

In the above-described aspect, a water accumulating portion may be included that accumulates water that has been generated on the surface of the cathode, and the moving unit may move the water absorbing member along the water accumulating portion.

According to the above-described aspect, hydrogen is supplied as fuel to the anode, and oxygen is supplied as an oxidant to the cathode, and the fuel cell generates electricity by an electrochemical reaction occurring through the solid polymer membrane.

When this occurs, there is water generated at the surface of the cathode by the electrochemical reaction between the fuel and oxygen.

However, since the water accumulating portion accumulates the water that has been generated on the surface of the cathode, and the moving unit moves the water absorbing member along the water accumulating portion, the water that has been generated on the surface of the cathode may be absorbed and removed.

In the above-described aspect, the surface of the cathode may be provided with a hydrophobic portion that has hydrophobic properties, and a hydrophilic portion, as the water accumulating portion, that has hydrophilic properties.

According to the above-described aspect, the hydrophobic portion provided to the surface of the cathode repels the water that has been generated on the surface of the cathode, and the water that has been repelled by the hydrophobic portion is accumulated in the hydrophilic portion that has hydrophilic properties, acting as the water accumulating portion.

Then, since the moving unit moves the water absorbing member along the hydrophilic portion, the water that has been generated on the surface of the cathode, and accumulated in the hydrophilic portion, may be absorbed and removed.

In the above-described aspect, the cathode may be provided with an inclined face that slopes toward the water accumulating portion.

According to the above-described aspect, the water that has been generated on the surface of the cathode may be accumulated to the water accumulating portion by gravity, since the cathode is provided with the inclined face sloped toward the water accumulating portion

In the above-described aspect, the water accumulating portion may include a soak member that abuts the cathode and that takes up water that has been generated on the surface of the cathode.

According to the above-described aspect, the soak member that configures the water accumulating portion abuts the cathode and takes up water that has been generated on the surface of the cathode using capillary action.

Then, since the moving unit moves the water absorbing member along the soak member, the water that has been generated on the surface of the cathode, and taken up by the soak member, may be removed.

In the above-described aspect, the cathode may be provided with an inclined face that slopes toward the absorbing member.

According to the above-described aspect, since the cathode is provided with the inclined face sloped toward the soak member, the water that has been generated on the surface of the cathode may be taken up by the soak member using gravity and capillary action.

In the above-described aspect, the moving unit may include: a guide unit that guides the water absorbing member along the water accumulating portion; and a manual operation member that manually moves the water absorbing member along the guide unit.

According to the above-described aspect, the manual operation member manually moves the water absorbing member, guided by the guide unit, along the water accumulating portion. The water that has been generated on the surface of the cathode and accumulated in the water accumulating portion may thereby be appropriately removed.

In the above-described aspect, a fuel cartridge may be included that supplies fuel to the anode, and a accommodating portion may be included that accommodates the fuel cartridge. The moving unit may include a sliding member that is disposed at the accommodating portion so as to be able to move and that is connected to the water absorbing member, and include a movement converting unit that converts detaching and attaching movement of the fuel cartridge, from and to the accommodating portion, into conveying movement of the sliding member.

According to the above-described aspect, a fuel cartridge is provided that supplies hydrogen to the anode, and the fuel cartridge is accommodated in the accommodating portion.

The sliding member that is connected to the water absorbing member is disposed at the accommodating portion so as to be able to move, and in addition the movement converting unit converts detaching and attaching movement of the fuel cartridge, from and to the accommodating portion, into the conveying movement of the sliding member.

Thereby, when the fuel cartridge is attached and detached to and from the accommodating portion, the movement converting unit converts detaching and attaching movement into the conveying movement of the sliding member, and the absorbing member that is connected to the sliding member is moved along the water accumulating portion by the movement of the sliding member.

The water that has been generated on the surface of the cathode and accumulated in the water accumulating portion may be removed by detaching and attaching the fuel cartridge in this manner.

In the above-described aspect, the water absorbing member may be a water absorbing block, and the moving unit may slide the water absorbing block along the water accumulating portion.

According to the above-described aspect, the water that has been generated on the surface of the cathode may be absorbed and removed by the moving unit sliding the water absorbing block along the water accumulating portion.

In the above-described aspect, a squeeze unit may be included that squeezes out water that has been absorbed by the water absorbing member, and a collection unit may be included that collects water that has been squeezed out by the squeeze unit.

According to the above-described aspect, the squeeze unit squeezes out water that has been absorbed by the water absorbing member, and in addition, the collecting unit collects the water that has been squeezed out by the squeeze unit.

The water absorbing member may thereby always sufficiently remove water of the water accumulating portion.

According to the present invention, water that has been generated on the surface of a cathode may be removed.

The foregoing description of the exemplary embodiments of the present invention is provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A fuel cell device comprising:
a fuel cell including an anode as a fuel electrode, a cathode as an oxidant electrode, and a solid polymer membrane that is disposed between the anode and the cathode;
a water absorbing member that absorbs water; and
a moving unit that moves the water absorbing member along a surface of the cathode.

2. The fuel cell device according to claim 1, wherein:
the fuel cell is provided to an electrical device that has an opening and closing portion; and
the moving unit comprises an opening and closing movement coupling member that has one end thereof fixed to the body of the electrical device and has the other end thereof attached to the opening and closing portion so as to be able to slide, and that converts opening and closing movement of the opening and closing portion into conveying movement of the water absorbing member.

3. The fuel cell device according to claim 1, wherein the moving unit comprises a guide unit that guides the water absorbing member along the surface of the cathode, and a manual operation member that manually moves the water absorbing member along the guide unit.

4. The fuel cell device according to claim 1, further comprising:
a fuel cartridge that supplies fuel to the anode; and
an accommodating portion that accommodates the fuel cartridge,
wherein the moving unit comprises a sliding member that is disposed at the accommodating portion so as to be able to move and that is connected to the water absorbing member, and a movement converting unit that converts detaching and attaching movement of the fuel cartridge, from and to the accommodating portion, into conveying movement of the sliding member.

5. The fuel cell device according to claim 1, wherein the water absorbing member is a water absorbing block, and the moving unit slides the water absorbing block along the surface of the cathode.

6. The fuel cell device according to claim 1, wherein the water absorbing member is a water absorbing sheet that is wound up on a shaft, and the moving unit pulls out along the surface of the cathode, and takes up, the water absorbing sheet.

7. The fuel cell device according to claim 1, wherein the water absorbing member is a water absorbing sheet strip that is folded up and accommodated, and the moving unit opens up along the surface of the cathode, and accommodates, the water absorbing sheet strip.

8. The fuel cell device according to claim 1, wherein the water absorbing member is a water absorbing roll, and the moving unit rolls the water absorbing roll along the surface of the cathode.

9. The fuel cell device according to claim 1, further comprising a timing control unit that actuates the moving unit for every predetermined electricity generation duration.

10. The fuel cell device according to claim 1, further comprising a timing control unit that actuates the moving unit for every predetermined electricity generation amount.

11. The fuel cell device according to claim 1, further comprising a timing control unit that actuates the moving unit when a voltage of the fuel cell has become a predetermined voltage or below.

12. The fuel cell device according to claim 1, further comprising a timing control unit that actuates the moving unit when a change in voltage of the fuel cell has exceeded a predetermined rate.

13. The fuel cell device according to claim 1, further comprising a timing control unit that actuates the moving unit when current and voltage characteristics of the fuel cell have ceased to satisfy predetermined characteristics.

14. The fuel cell device according to claim 1, wherein a water absorbing area of the water absorbing member is less than a surface area of the cathode.

15. The fuel cell device according to claim 1, wherein the surface of the cathode is provided with a protection member that allows water to come out of a surface thereof.

16. The fuel cell device according to claim 1, further comprising:
a squeeze unit that squeezes out water that has been absorbed by the water absorbing member; and
a collection unit that collects water that has been squeezed out by the squeeze unit.

17. The fuel cell device according to claim 1, further comprising a water accumulating portion that accumulates water that has been generated on the surface of the cathode, wherein the moving unit moves the water absorbing member along the water accumulating portion.

18. The fuel cell device according to claim 17, wherein the surface of the cathode is provided with a hydrophobic portion that has hydrophobic properties, and a hydrophilic portion, as the water accumulating portion, that has hydrophilic properties.

19. The fuel cell device according to claim 17, wherein the cathode is provided with an inclined face that slopes toward the water accumulating portion.

20. The fuel cell device according to claim 17, wherein the water accumulating portion includes a soak member that abuts the cathode and that takes up water that has been generated on the surface of the cathode.
